(19) United States
(12) Patent Application Publication
(10) Pub. No.: US 2019/0075998 A1
(43) Pub. Date: Mar. 14, 2019

(54) HEAVY DUTY WASHING APPARATUS

(71) Applicant: RP Ideas Pty Ltd, Mentone (AU)

(72) Inventors: Richard Parsons, Mentone (AU); Salvina Parsons, Mentone (AU)

(21) Appl. No.: 16/180,664

(22) Filed: Nov. 5, 2018

Related U.S. Application Data
(63) Continuation-in-part of application No. PCT/AU2017/050420, filed on May 8, 2017.

(30) Foreign Application Priority Data
May 6, 2016 (AU) 2016901670

(51) Int. Cl. A47L 15/00; A47L 15/42; A47L 15/44; B08B 3/00; B08B 3/02; B08B 3/08; C11D 11/00; C11D 3/04

(52) U.S. Cl. CPC A47L 15/0092; A47L 2601/20; A47L 15/4285; A47L 15/44; A47L 15/4214; A47L 15/0031; A47L 15/0028; A47L 15/0034; A47L 15/0026; B08B 3/003; B08B 3/02; B08B 3/08; C11D 11/0023; C11D 3/044; C11D 3/042; B08B 2203/007; B08B 2203/0217; B08B 2203/0258; A47L 2601/02; A47L 15/4289

(57) ABSTRACT

A heavy duty washing apparatus for cleaning cooking substrates including hotplates and grills comprising: a. a self-contained housing allowing readily movability; b. a plurality of functionally interconnected stations for receiving supply of water, a chemical cleaning agent composition and a pressurised fluid; c. a pressurising station and a temperature conditioning station; d. a foam generator in the housing using controlling feeds from the plurality of interconnected stations and functionally engaging with the pressurising station and the temperature conditioning station for providing an effective chemical cleaning agent composition for conditioning one or more of the supply of water, the chemical cleaning agent composition and the pressurised fluid and e. a washing compartment adapted to receive one or more of the cooking substrates in a stackable substantially planar spaced array; wherein the effective chemical cleaning agent composition allows for cleaning over an effective cleaning time in a chemical, aerobic and physical manner cooking residues on the cooking substrates by retaining of said foam layer for a predetermined period in contact with the cooking surfaces, and rinsing the foam layer with preselected conditioned high temperature and/or pressurised water to remove chemical and food residues.

### FIELD OF THE INVENTION

The present invention relates to a heavy duty washing apparatus. In particular the present invention relates to a mobile washer for primary use in outdoors for cleaning grills and heavy duty hot plates and heavily soiled articles effective to substantially reduce labor intensity while maintaining high quality finishes. However it could include other mobile washers.

The invention has been developed primarily for use in/with a mobile washer unit for washing heavy duty grills and hot plates and the like which are exposed to heavy soiling including cooking apparatuses such as barbeques and will be described hereinafter with reference to this application. However, it will be appreciated that the invention is not limited to this particular field of use.

### BACKGROUND OF THE INVENTION

Barbeques or the like cooking apparatuses having cooking surfaces such as hot plates and array of open grills are known which receive foods including meat, chicken, fish and vegetables and the like for direct or indirect cooking. Barbeques often signify and provide a functional means by which a social occasion may be had or based.

As a general hygienic approach, the cooking surfaces need to be cleaned after every use so as to provide a clean surface on which to conduct a barbeque, and to maintain the cooking surfaces from deterioration such as rusting and the need for regular replacement.

Often, after a social occasion has finished, a host may be less inclined to clean cooking surfaces not the least because the surfaces are usually significantly soiled with residual foodstuffs, fat, grease and oils that can be time consuming and labor intensive to clean. Domestic dish washers of a type plumbed into internal water supply are generally not effective for cleaning heavy cooking surfaces saturated with fats, residual food, grease and oils.

Therefore it is not unusual for a host to simply leave the cooking surfaces on a barbeque and clean the surfaces just before the next use or social event. In the meantime there can be deterioration and residual foodstuffs attracting undesirable insect activity such as cockroaches. An alternative means for cleaning is required.

The present washing system is merely a water washing with a detergent. Dishwashers will follow cycles where the detergent is activated and flushed around the cabinet by water jets in rotating arms followed by cycles with plain water flushing and heating cycle for drying contents. As this is in the domestic arena, the detergents are mild and the cabinetry is merely watertight but not sealed. This form of cleaning is limited to standard low intensity washing such as everyday crockery and cutlery. The cycles rely heavily on the heated water recirculation and reflushing of the domestic In order to allow for the cleaning the process is drawn out over extended periods of over an hour. Such system cannot handle heavy soiling such as the burnt and greasy surfaces of hot plates and grills such as associated with barbeques (BBQ).

It is known to have a commercial dishwasher for commercial premises such as restaurants. Such commercial systems use water and detergent at higher temperatures and higher pressures of flushing. However such systems are merely to speed up the process so that a high turnover allows many reuses of crockery and cutlery and glassware in a restaurant. This limits the amount of crockery and cutlery and glassware that needs to be purchased. Again such systems cannot handle heavy soiling such as the burnt and greasy surfaces of hot plates and grills such as associated with barbeques (BBQ). In restaurants therefore pots and pans are hand cleaned.

It can be seen that known prior art washing systems to have problems including one or more of:
a. Being reliant on mild detergents;
b. Primarily requiring water flushing to clean;
c. Not allowing more intensive cleaning agents suitable for cleaning burnt and greasy surfaces of hot plates and grills;
d. Being limited to water based cleaning agents;
e. Not allowing cleaning agents to act over time;

The present invention seeks to provide a heavy duty washer, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, there is provided a heavy duty washing apparatus for cleaning cooking substrates including hotplates and grills comprising:

a mobile housing including:

a. a plurality of interconnected stations for conditioning a supply of water, the stations including a pressurising station and a temperature conditioning station; and

b. a washing compartment adapted to receive one or more of the cooking substrates in a stackable array;
wherein the washing apparatus is connectable to a water supply feeding to the conditioning stations, and the washing compartment connected downstream of the conditioning stations including at least one inlet for receiving the conditioned water;
wherein the conditioning stations provide a high pressure and high temperature cleaning to the cooking substrates in the washing compartment.

The heavy duty washing apparatus of the present invention represents a substantial improvement over the prior art. The washing apparatus allows convenient and effective washing of heavily soiled cooking articles such as hot plates and grills. It is clear that a domestic washing machine cannot be readily moved from one location to another. The mobility of the present washer apparatus allows for easy transporting.

The apparatus can further include an integrated processor means for controlling conditions at the conditioning stations.

In a related aspect there is disclosed a heavy duty washing apparatus for cleaning cooking substrates including hotplates and grills comprising:
a. a self-contained housing allowing readily movability;
b. a plurality of functionally interconnected stations for receiving supply of water, a chemical cleaning agent composition and a pressurised fluid;
c. a pressurising station and a temperature conditioning station;
d. a foam generator in the housing using controlling feeds from the plurality of interconnected stations and functionally engaging with the pressurising station and the temperature conditioning station for providing an effective chemical cleaning agent composition for conditioning one or more of the supply of water, the chemical cleaning agent composition and the pressurised fluid and
e. a washing compartment adapted to receive one or more of the cooking substrates in a stackable substantially planar spaced array;
   wherein the effective chemical cleaning agent composition allows for cleaning over an effective cleaning time in a chemical, aerobic and physical manner cooking residues on the cooking substrates by retaining of said foam layer for a predetermined period in contact with the cooking surfaces, and rinsing the foam layer with preselected conditioned high temperature and/or pressurised water to remove chemical and food residues.

This combined ability to provide conditioning to water and cleaning fluid, and retaining a foamed layer of cleaning fluid in cleaning contact with heavily soiled grills or hotplates with food, proteins, fats and the like, as well as rinsing and controls represents a departure from and improvement over existing systems.

The effective chemical cleaning agent composition can be selected from:
1. a concentrate cleaning composition comprising:
   a. an amount of about 10-30% w/w NaOH,
   b. an amount of less than about 10% w/w of a surfactant, and
   c. an amount of less than about 10% w/w sodium.
2. a concentrate cleaning composition comprising:
   d. hypochlorous acid in an amount of less than about 10% w/w, and
   e. sodium hydroxide in an amount of less than about 10% w/w;
3. Potassium Hydroxide in an amount of less than about 6% w/w, and sodium hypochlorite in an amount of less than about 6% w/w.

Preferably the cleaning composition is a mixture of composition 1 and 2 in an aqueous solution with a volume ratio of composition 1 and 2 and water is about 1:1:2.

In operation, a predetermined volume of the preferred concentrate can be delivered and combined with an equal volume of water. Other compositions that have been found to provide suitable ranges of viscosity, adhesiveness and foaming thickness include:
a. The effective cleaning time can be greater than 15 minutes. Preferably the effective cleaning time is substantially between 15 and 30 minutes.
b. The effective chemical cleaning agent composition can be formed into an effective foam form for remaining located on a cooking substrate for the effective cleaning time.

The plurality of interconnected stations and the washing apparatus can be connectable to the water supply feeding to the foam generator and the washing compartment connected downstream of the foam generator is controlling the supply of the chemical cleaning agent composition, water and pressurising fluid from the interconnected stations to provide the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact of between about 15 minutes to 30 minutes.

The washing apparatus can further include one or more sets of dispersal jets or nozzles are located substantially in linear form parallel to the substantially parallel cooking substrates.

The at least one set of dispersal jets or nozzles can be located substantially perpendicular to the substantially parallel cooking substrates such that effective chemical cleaning agent composition in the form of a foam can be applied within the spaced parallel surfaces of the cooking substrates in substantially planar spaced array. In one embodiment the two sets of dispersal jets or nozzles are located at substantially perpendicular to each other. In an alternative embodiment the dispersal jets or nozzles are located at a periphery of the substantially in linear form parallel to the substantially parallel cooking substrates.

Preferably the outlet of the washing compartment has a sealable closure switchable between two or more of the following:
a. Projection mode for sealing washing compartment and allowing projection of effective chemical cleaning agent composition into the sealed washing compartment without chance of dispersal to the atmosphere;
b. Washing mode for allowing time effective cleaning in the sealed washing compartment while allowing pressure and temperature condition;
c. Deactivation mode in which the washing compartment is sealed for receipt of deactivating water or chemical deactivates foam of the effective chemical cleaning agent composition without dispersal to the atmosphere;
d. First Dispersal mode in which the washing compartment is sealed for receipt of flushing water or chemical for flushing of the effective chemical cleaning agent composition towards a drainage sump without dispersal to the atmosphere;
e. Second dispersal mode in which drainage sump is open for drainage of the flushed and/or deactivated effective chemical cleaning agent composition.

The housing can be a self-contained housing having at least one washing compartment therein and which housing can be readily movable, and the washing compartment adapted to receive one or more of the cooking substrates in a stackable substantially spaced planar array.

The washing compartment can also include a series of inlets and an internal non-corrosive liner and at least one outlet.

The plurality of interconnected stations within the housing can include:
a. a water station having input connection for supplying water and the water station preferably including associated temperature and pressure modules for conditioning of the temperature and/or pressure of the water;
b. a chemical station having input connection for a chemical cleaning agent composition preferably from a pressurised canister;
c. a pressure station for supplying pressurised fluid preferably as air pressure;

The heavy duty washing apparatus can include a supply controller connected to the fluid interconnection to the washing compartment directly or indirectly from the interconnected stations in order to provide:
a. a chemical cleaning agent composition in an effective form;
b. water separately or in combination with the chemical cleaning agent composition in order to aid the provision of the chemical cleaning agent composition in an effective form;
c. pressurising fluid separately or in combination with water and/or with the chemical cleaning agent composition in order to aid the provision of the chemical cleaning agent composition in an effective form;
d. dispersing, via the series of inlets to the washing compartment, the effective form of the chemical cleaning agent composition along the substantially spaced planar array of the cooking substrates.

The apparatus can further include a foaming controller controlling the supply of the chemical cleaning agent composition, water and pressurising fluid from the interconnected stations to provide:
a. the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact of between about 15 minutes to 30 minutes;
b. an effective chemical cleaning agent composition for cleaning in a chemical, aerobic and physical manner cooking residues on the cooking substrates;

The heavy duty washing apparatus can further include a projection controller controlling the projection of the effective chemical cleaning agent composition into the washing compartment wherein the projection control provides:
a. a dispersal of the effective chemical cleaning agent composition in the form of the foam at low pressure and wide foaming dispersal jets or nozzles which allows the foam to be retained on the cooking substrates to allow producing a cleaning foam composition of predetermined concentration and adhesiveness of between about 15 minutes to 30 minutes;
b. a high temperature in the washing compartment preferably greater than 75 degrees Celsius to aid chemical and/or water cleaning to the cooking substrates in the washing compartment and/or
c. a high pressure projection of effective chemical cleaning agent composition and/or water to aid physical cleaning;
d. the projection control provides controlling the dispersal of the effective chemical cleaning agent composition by application of one or more of:
   i.supply and control of water to provide flushing;
   ii. supply and control of chemical dispersal agent to provide deactivation or flow characteristics of the effective chemical cleaning agent composition
   iii.supply and control of pressurised fluid into the washing compartment wherein the control aids flushing;

The apparatus can further include an integrated processor means for controlling conditions at the conditioning stations.

The washing compartment can include one or more chambers which each further includes:
a. a base adapted to receive one or more grill plates or hot plates for cleaning, the base being divided into a grill plate or hot plate receiving portion and a drainage portion adjacent the grill plate receiving portion, wherein the grill plate receiving portion and drainage portion define a flow pathway therebetween to an outlet in the drainage; and
b. an adjustable closure operable between a closed position and an open position between the grill plate receiving portion and the drainage portion:
c. a cleaning sub-assembly mounted to the chamber, the sub-assembly having:
d. a foam generating system interconnected to a concentrate cleaning composition, a water supply, and compressed air source for producing a cleaning foam composition of predetermined concentration and adhesiveness of between about 15 minutes to 30 minutes;
   2. a foam manifold interconnected to the foam generating system suspended a predetermined distance from the grill plate receiving portion of the base, and
   3. a rinsing manifold interconnected to the water supply;
      wherein in an operating condition, the grill plate receiving portion of the base receives a predetermined volume of the foamed composition to allow predetermined contact adhesion with the grill plate for a predetermined time, and exposing the foam composition to a rinsing cycle by the rinsing manifold, when the closure is moved to an open position to displace the foam composition to the drainage sump and outlet via the flow pathway.

The apparatus can further include one or more sensors located at the conditioning stations in communication with the processor.

The apparatus can further include a pump station for priming the water supply to increase water pressure through the high temperature conditioning station.

The apparatus can include a series of water pressure and temperature sensors.

The apparatus can include a plurality of wheels mounted to the external frame housing to provide transport of the apparatus.

The washing compartment can include a closure for allowing access thereto before and after washing.

The washing compartment can comprise a plurality of inlets spaced about the compartment to spray conditioned water over the soiled substrates.

The apparatus can further include a water storage compartment for storing a volume of water, wherein the water storage compartment is connectable to the pump station for drawing the supply through the conditioning stations.

The apparatus can further include a cleaner conditioning station for adding cleaners to the water.

The cleaner can include one or more of surfactants, detergents and/or chemicals, wherein the cleaner is merged into the water supply

The apparatus can further include a sub-assembly for storing containers of surfactants, detergents and/or chemicals, wherein the sub-assembly is interconnectable to the water supply

The washing compartment can further include a movable rack for receiving the substrates in a varying spaced parallel stackable array.

The heavy duty washing apparatus can further include a high-pressure dish-washing compartment which is a cleaning tool for flushing substrates through high temperature, high pressure and high speed small water flows. The cleaning tool can be configured in a way that hot water heated by a pressure bearing water heater runs through an adjusting valve, a high pressure hose and a high-pressure dish-washing inlet body which is formed by a valve, a gun body and a muzzle.

The appliances such as grills, hotplates, and the like, are washed under assisting functions of a disc rack and a U type transparent cover plate by means of about 0.7 MPa high pressure of tap water.

Preferably the plurality of inlets is arranged on one side of the washing compartment so that conditioned water spray is directed transverse to and between an array of adjacent stacked appliances to improve access to contact surfaces of the soiled substrates.

The plurality of inlets can also be arranged in the washing compartment above an array of adjacent stacked appliances so that conditioned water is directed downwardly and between the array to improve access to contact surfaces of the soiled substrates.

The plurality of inlets can be arranged in the washing compartment on one side transverse to the array of stacked substrates and above the array, so that conditioned water is directed substantially simultaneously laterally and downwardly and between the array to improve access to contact surfaces of the soiled substrates.

In a further related aspect of the present invention there is described a heavy duty mobile washing apparatus for cleaning cooking substrates including hotplates and grills comprising:
a. a mobile housing;
b. a plurality of interconnected stations for conditioning a supply of water, the stations including a pressurising station and a temperature conditioning station; and
c. a washing compartment adapted to receive one or more of the cooking substrates in a stackable array;
the washing apparatus connectable to a water supply feeding to the conditioning stations and the washing compartment connected downstream of the conditioning stations and including at least one inlet for receiving the conditioned water;
wherein the stations provide a high pressure and high temperature cleaning to the cooking substrates in the washing compartment.

The apparatus can further include an integrated processor means for controlling conditions at the conditioning stations.

The washing apparatus can further include a means for introducing a fluid or chemical under pressure to the washing compartment.

Preferably the mobile housing includes a cavity or recess for receiving a high pressure canister containing a chemical foam or the like.

Preferably the cavity further comprises an engagement means for interconnecting an outlet of the canister to the washing compartment for introducing a chemical foam into the washing compartment via an inlet.

The canister can be configured/pressurised to emit a fluid, and initiated in an engaged condition with the engagement means, and which forms a foam layer on contact with surfaces in the washing compartment including hot plates and grills and accessories.

The inlets in the washing compartment can include a terminal spray head adjustably located in the washing compartment for dispersing conditioned water and foam over surfaces of stacked cooking plates, grills and accessories.

The washing compartment can include a stainless steel of ceramic lining adapted to substantially withstand the chemicals emitted from the canister.

The stackable arrangement of items to be cleaned can be arranged in the washing compartment transverse to the spray heads so that incoming spray of conditioned water and/or fluid is directed between the stacked plates to be cleaned.

The apparatus can include a canister containing a chemical cleaning agent, whereby the canister is loaded into a dedicated inlet assembly on the mobile housing, wherein the inlet assembly is interconnectable to the washing compartment and actuates the canister for transporting and introducing pressurized fluid from the canister into the washing compartment, wherein the fluid forms a foam layer on contact with a surface to be cleaned. The foam layer can be allowed to remain on the contact surfaces for a preselect period of time.

Preferably the spray heads are configured to provide a velocity spray of incoming conditioned water.

The mobile housing is preferably sized to locate within a domestic or conventional cavity or recess hence can be moved between inside and external locations readily.

In a further related aspect of the present invention there is described a method of washing cooking substrates including hotplates and grills, including:

providing a unit with heavy duty washing apparatus comprising:
i.a mobile housing;
ii.a plurality of interconnected stations for conditioning a supply of water, the stations including a pressurising station and a temperature conditioning station; and
iii.a washing compartment adapted to receive one or more of the cooking substrates in a stackable array;
   connecting the washing apparatus to a water supply feeding to the conditioning stations; wherein the stations provide a cyclic high pressure and high temperature cleaning to the cooking substrates in the washing compartment.

In a further related aspect of the present invention there is described a method of washing cooking substrates including hotplates and grills, including:
a. providing a unit with heavy duty washing apparatus comprising:
   i. a mobile housing;
   ii. a plurality of interconnected stations within the housing for conditioning a supply of water, the stations including a pressurising station and a temperature conditioning station; and
   iii. a washing compartment within the housing interconnected downstream from the conditioning stations, the washing compartment adapted to receive one or more of the cooking substrates in a stackable array;
b. connecting the washing apparatus to a water supply feeding to the conditioning stations;
   wherein the stations provide a high pressure and high temperature cleaning to the cooking substrates in the washing compartment.

The conditioning stations can include temperature and pressure modules which are operated by a central processor to vary preselected temperature and pressure conditions.

The method can further include a plurality of preselected cycles including water temperature, pressure, soaking, time, and volume of water in the washing compartment.

The method can include sensing via a series of sensors and a central processor in communication with the sensors so that preselected cycles and conditions is pre-programmed and monitored so that energy can be conserved and preselect conditions substantially maintained.

The method can include introducing a select volume of preconditioned water in the washing compartment via an array of inlets, and allowing the volume of preconditioned water to remain in contact with cooking substrates in the washing compartment for a preselect period of time.

The method can include providing a canister containing a chemical cleaning agent, whereby the canister is loaded into a dedicated inlet assembly on the mobile housing, wherein the inlet assembly is interconnectable to the washing compartment and actuates the canister for transporting and introducing pressurized fluid from the canister into the washing compartment, wherein the fluid forms a foam layer on contact with a surface to be cleaned.

Preferably the foam layer is allowed to remain on the contact surfaces for a preselect period of time.

Preferably the method of washing cooking substrates further includes introduction of conditioned water to remove chemically reacted residues, and/or surfactants to further solubilize greases and other built-up foods, before rinsing or further soaking with high temperature water.

The chemically treated residues can be pretreated by exposure to high pressure and high temperature conditioned water to assist removal of grease, fat, and other combinations of foods and oleaginous material build up.

In a further related aspect of the present invention there is described a method of heavy duty washing of cooking substrates including hotplates and grills, the method including the steps of:
a. providing a self-contained housing having at least one washing compartment therein and which housing can be readily movable, and the washing compartment adapted to receive one or more of the cooking substrates in a stackable substantially spaced planar array, wherein the washing compartment includes a series of inlets and an internal non-corrosive liner and at least one outlet;
b. providing a plurality of interconnected stations within the housing including:
   i. a water station having input connection for supplying water and the water station preferably including associated temperature and pressure modules for conditioning of the temperature and/or pressure of the water;
   ii. a chemical station having input connection for a chemical cleaning agent composition preferably from a pressurised canister;
   iii. a pressure station for supplying pressurised fluid preferably as air pressure;
   iv. providing fluid interconnection to the washing compartment directly or indirectly from the interconnected stations in order to provide:
      1. a chemical cleaning agent composition in an effective form;
      2. water separately or in combination with the chemical cleaning agent composition in order to aid the provision of the chemical cleaning agent composition in an effective form;
      3. pressurising fluid separately or in combination with water and/or with the chemical cleaning agent composition in order to aid the provision of the chemical cleaning agent composition in an effective form;
      4. dispersing, via the series of inlets to the washing compartment, the effective form of the chemical cleaning agent composition along the substantially spaced planar array of the cooking substrates;
c. controlling the supply of the chemical cleaning agent composition, water and pressurising fluid from the interconnected stations to provide:
   i. the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact of between about 15 minutes to 30 minutes;
   ii. an effective chemical cleaning agent composition for cleaning in a chemical, aerobic and physical manner cooking residues on the cooking substrates;
d. controlling the projection of the effective chemical cleaning agent composition into the washing compartment wherein the control provides:
   i. a dispersal of the effective chemical cleaning agent composition in the form of the foam at low pressure and wide foaming dispersal jets or nozzles which allows the foam to be retained on the cooking substrates to allow producing a cleaning foam composition of predetermined concentration and adhesiveness of between about 15 minutes to 30 minutes;
   ii. and a high temperature in the washing compartment preferably greater than 75 degrees Celsius to aid chemical and/or water cleaning to the cooking substrates in the washing compartment and/or
   iii. a high pressure projection of effective chemical cleaning agent composition and/or water to aid physical cleaning;
e. controlling the dispersal of the effective chemical cleaning agent composition by application of one or more of:
   i. supply and control of water to provide flushing;
   ii. supply and control of chemical dispersal agent to provide deactivation or flow characteristics of the effective chemical cleaning agent composition
   iii. supply and control of pressurised fluid into the washing compartment wherein the control aids flushing;
      wherein the method allows retaining of said foam layer for a predetermined period in contact with the cooking surfaces, and rinsing the foam layer with preselected conditioned high temperature and/or pressurised water to remove chemical and food residues.

Preferably the chemical cleaning agent composition is selected from:
a. Composition 1: a concentrate cleaning composition comprising:
   i. an amount of about 10-30% w/w NaOH,
   ii. an amount of less than about 10% w/w of a surfactant, and
   iii. an amount of less than about 10% w/w sodium.
b. Composition 2: a concentrate cleaning composition comprising:
   i. hypochlorous acid in an amount of less than about 10% w/w, and
   ii. sodium hydroxide in an amount of less than about 10% w/w;
c. Composition 3: Potassium Hydroxide in an amount of less than about 6% w/w, and sodium hypochlorite in an amount of less than about 6% w/w.
d. Composition 4: a mixture of composition 1 and 2 in an aqueous solution with a volume ratio of composition 1 and 2 and water is about 1:1:2.

The method can further include introducing the chemical cleaning agent composition in a disposable form from a canister mountable to the input connection of the chemical station for receiving the chemical cleaning agent composition.

The method can further include sensing via a series of sensors located at or close to the conditioning stations and washing department to monitor conditioning and washing parameters, and a central processor in operating communication with the sensors to receive input data from the sensors and operate the modules of the conditioning stations

The apparatus can further include one or more sensors located at the conditioning stations in communication with the processor.

The apparatus can further include a pump station for priming the water supply to increase water pressure through the high temperature conditioning station.

The apparatus can include a series of water pressure and temperature sensors.

The apparatus can include a plurality of wheels mounted to the external frame housing to provide transport of the apparatus.

The washing compartment can include a closure for allowing access to a washing compartment. In a further embodiment, the mobile housing can include counter opening doors to access the washing compartment.

The washing compartment comprises a plurality of inlets spaced about the compartment and a network of conduits interconnecting inlets to the conditioning stations to select a range of modes of operation including to introduce spray conditioned water over the soiled substrates.

Preferably the plurality of inlets is arranged on one side of the washing compartment so that conditioned water spray is directed transverse to and between an array of adjacent stacked appliances to improve access to contact surfaces of the soiled substrates.

Preferably the plurality of inlets is arranged in the washing compartment above an array of adjacent stacked appliances so that conditioned water is directed downwardly and between the array to improve access to contact surfaces of the soiled substrates.

Preferably the plurality of inlets is arranged in the washing compartment on one side transverse to the array of stacked substrates and above the array, so that conditioned water is directed substantially simultaneously laterally and downwardly and between the array to improve access to contact surfaces of the soiled substrates.

The apparatus can further include a water storage compartment for storing a volume of water, wherein the water storage compartment is connectable to the pump station for drawing the supply through the conditioning stations.

The apparatus can further include a cleaner conditioning station for adding cleaners to the water.

The cleaner conditioning station can include one or more of surfactants, detergents and/or chemicals, wherein the cleaner is merged into the water supply.

The apparatus can further include a sub-assembly for storing containers of surfactants, detergents and/or chemicals, wherein the sub-assembly is interconnectable to the water supply.

The washing compartment can further include a movable rack for receiving the substrates in a stackable array. The rack can be automatically movable by hydraulic means.

In a related aspect there is disclosed a high-pressure dish-washing compartment which is a cleaning tool for flushing substrates through high temperature, high pressure and high speed small water flows.

The cleaning tool is configured in a way that hot water heated by a pressure bearing water heater runs through an adjusting valve, a high pressure hose and a high-pressure dish-washing inlet body which is formed by a valve, a gun body and a muzzle,

Appliances such as grills, hot plates, pots and pans are washed under assisting functions of a disc rack and transparent cover plate by means of about 0.7 MPa high pressure of tap water. The high-pressure dish-washing has the advantages of being water-saving, energy-saving, environmental-friendly and clean.

In a further related aspect of the present invention there is disclosed a method of treatment aid for washing comprising a heavy duty washing apparatus for cleaning a heavily soiled substrate(s) such as hotplates and barbeque grills comprising: an external wheeled frame housing being connectable to a water supply and having a plurality of interconnected stations for conditioning a supply of water, the stations including high pressure and high temperature conditioning; a washing compartment downstream of the conditioning stations adapted to receive one or more of the substrates in a stackable array, the washing compartment including at least one inlet for receiving the conditioned water; an integrated processor means for controlling conditions at the conditioning stations; one or more sensors located at the conditioning stations in communication with the processor; wherein the stations

Preferably the plurality of inlets is arranged on one side of the washing compartment so that conditioned water spray is directed transverse to and between an array of adjacent stacked appliances to improve access to contact surfaces of the soiled substrates.

The plurality of inlets can be arranged in the washing compartment above an array of adjacent stacked appliances so that conditioned water is directed downwardly and between the array to improve access to contact surfaces of the soiled substrates.

Preferably the plurality of inlets is arranged in the washing compartment on one side transverse to the array of stacked substrates and above the array, so that conditioned water is directed substantially simultaneously laterally and downwardly and between the array to improve access to contact surfaces of the soiled substrates.

In one embodiment the mobile housing of the washing apparatus can further include a means for introducing a fluid or chemical under pressure to the washing compartment. Preferably the mobile housing can include a cavity or recess for receiving a high pressure canister containing a chemical foam or the like. The cavity can further comprise an engagement means for interconnecting an outlet of the canister to the washing compartment for introducing a chemical foam into the washing compartment via an inlet. The canister can be configured/pressurised to emit a fluid, and initiated in an engaged condition with the engagement means, and which forms a foam layer on contact with surfaces in the washing compartment including hot plates and grills and accessories.

Preferably the inlets in the washing compartment include a terminal spray head adjustably located in the washing compartment for dispersing conditioned water and foam over surfaces of stacked cooking plates, grills and accessories.

The washing compartment can include a stainless steel of ceramic lining adapted to substantially withstand the chemicals emitted from the canister.

Preferably the stackable arrangement of items to be cleaned are arranged in the washing compartment transverse to the spray heads so that incoming spray of conditioned water and/or fluid is directed between the stacked plates to be cleaned. In this way the surface area of items exposed to conditioned water and/or fluid/foam is maximized.

The apparatus can include a canister containing a chemical cleaning agent, whereby the canister is loaded into a dedicated inlet assembly on the mobile housing, wherein the inlet assembly is interconnectable to the washing compartment and actuates the canister for transporting and introducing pressurized fluid from the canister into the washing compartment, wherein the fluid forms a foam layer on contact with a surface to be cleaned. The foam layer can be allowed to remain on the contact surfaces for a preselect period of time.

In one preferred aspect the spray heads are configured to provide a velocity spray of incoming conditioned water.

Preferably the mobile housing is sized to locate within a domestic or conventional cavity or recess hence can be moved between inside and external locations readily.

In a further related aspect of the present invention there is disclosed a method of washing cooking substrates including hotplates and grills, including:
providing a unit with heavy duty washing apparatus comprising:
   a. a mobile housing;
   b. a plurality of interconnected stations within the housing for conditioning a supply of water, the stations including a pressurising station and a temperature conditioning station; and
   c. a washing compartment within the housing interconnected downstream from the conditioning stations, the washing compartment adapted to receive one or more of the cooking substrates in a stackable array;
connecting the washing apparatus to a water supply feeding to the conditioning stations;
wherein the stations provide a high pressure and high temperature cleaning to the cooking substrates in the washing compartment.

The conditioning stations can include temperature and pressure modules which can be operated by a central processor to vary preselected temperature and pressure conditions.

In a further preferred method of the invention, the apparatus can comprise a plurality of preselected cycles including water temperature, pressure, soaking, time, and volume of water in the washing compartment. The apparatus can include a series of sensors and a central processor in communication with the sensors so that preselected cycles and conditions can be pre-programmed and monitored so that energy can be conserved and preselect conditions substantially maintained.

In yet a further embodiment, the method can include introducing a select volume of preconditioned water in the washing compartment via an array of inlets, and allowing the volume of preconditioned water to remain in contact with cooking substrates in the washing compartment for a preselect period of time.

In one preferred form, the method can include providing a canister containing a chemical cleaning agent, whereby the canister is loaded into a dedicated inlet assembly on the mobile housing, wherein the inlet assembly is interconnectable to the washing compartment and actuates the canister for transporting and introducing pressurized fluid from the canister into the washing compartment, wherein the fluid forms a foam layer on contact with a surface to be cleaned. The foam layer can be allowed to remain on the contact surfaces for a preselect period of time. The method can further include introduction of conditioned water to remove chemically reacted residues, and/or surfactants to further solubilize greases and other built-up foods, before rinsing or further soaking with high temperature water. Alternatively, the chemically treated residues can be exposed to high pressure and high temperature conditioned water to assist removal of grease, fat, and other combinations of foods and oleaginous material build up.

In yet a further related aspect of the present invention there is disclosed a method of washing cooking substrates including hotplates and grills, including:
providing a unit with heavy duty washing apparatus comprising:
   a. a mobile housing including a motor;
   b. a plurality of interconnected stations within the housing for conditioning a supply of water, the stations including associated temperature and pressure modules for said conditioning of temperature and/or pressure;
   c. a washing compartment within the housing interconnected downstream from the conditioning stations, the washing compartment adapted to receive one or more of the cooking substrates in a stackable array, wherein the washing compartment includes a series of inlets and internal non-corrosive liner;
   d. a series of sensors located at or close to the conditioning stations and washing department to monitor conditioning and washing parameters,
   e. a central processor in operating communication with the sensors to receive input data from the sensors and operate the modules of the conditioning stations
   f. a chemical station in the housing and fluid injection system for transferring a chemical in a fluid form from the receiving platform to the washing compartment,
   g. a pressurised canister containing a chemical cleaning agent composition,
connecting the washing apparatus to a water supply feeding to the conditioning stations;
wherein the stations provide a high pressure and high temperature cleaning to the cooking substrates in the washing compartment, and wherein the method further includes introducing chemical in a fluid form from the canister into the washing compartment whereby a foam layer if formed on contact with cooking surfaces to be cleaned, retaining said foam layer for a predetermined period in contact with the cooking surfaces, and rinsing the foam layer with preselected conditioned high temperature and/or pressurised water to remove chemical and food residues.

In yet a further related aspect of the invention there is disclosed a chamber forming part of the washing apparatus, the chamber including: a base adapted to receive one or more grill plates or hot plates for cleaning, the base being divided into a grill plate or hot plate receiving portion and a drainage portion adjacent the grill plate receiving portion, wherein the grill plate receiving portion and sump portion define a flow pathway therebetween to an outlet in the drainage sump; and an adjustable closure operable between a closed position and an open position: a cleaning sub-assembly mounted to the chamber, the sub-assembly having: a foam generating system interconnected to a cleaning composition and a water supply, a foam manifold interconnected to the foam generating system suspended a predetermined distance from the grill plate receiving portion of the base, and a rinsing manifold; wherein the grill plate receiving portion of the base receives a predetermined volume of foamed composition to allow contact with the grill plate for a predetermined time, and exposing the foam composition to a rinsing cycle by the rinsing manifold, when the closure is moved to an open position, to displace the foam composition to the drainage sump and outlet.

In a further related aspect of the present invention there is disclosed a heavy duty washing apparatus for cleaning cooking substrates including hotplates and grills comprising: a self-contained housing allowing readily movability, the housing having: a washing compartment including: a base adapted to receive one or more grill plates or hot plates for cleaning, the base being divided into a grill plate or hot plate receiving portion and a drainage portion adjacent the grill plate receiving portion, wherein the grill plate receiving portion and drainage portion define a flow pathway therebetween to an outlet in the drainage; an adjustable closure operable between a closed position and an open position between the grill plate receiving portion and the drainage portion; and at least one inlet manifold interconnected to a foam and water supply sub-assembly for controlled ingress of water and timed exposure of cooking substrates to be cleaned to an effective amount of a foamed cleaning composition; the water and foam sub-assembly located beneath the washing compartment supported by the housing and interconnected to the at least one inlet manifold, and including: an inlet port for receiving a cartridge containing chemical cleaning agent composition selected from any of the compositions disclosed above; a compressor downstream from the inlet port adapted to receive a measured supply of the chemical cleaning agent composition from the cartridge and combine with a high pressure air source, wherein the compressor produces a foam having viscosity and adhesive characteristics effective to allow retention of the foam on the soiled plates or grills for a period of time, wherein in a cleaning condition the compressor delivers the foam to the washing compartment via the at least one inlet manifold in a cleaning cycle; a water reservoir having an inlet connectable to a water supply wherein the water reservoir is delivered to the at least one inlet manifold at a predetermined time according to a rinsing cycle; and a switching means for controlling washing cycles between the sub-assembly and the washing compartment and removal of waste from the compartment.

The process of washing can be cyclical.

Other aspects of the invention are also disclosed with reference to accompanying drawings and examples.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a schematic flow diagram representing general operation of a mobile washer for washing in accordance with a preferred embodiment of the present invention;

FIG. 2 is a schematic perspective view of a mobile washer for washing in accordance with a preferred embodiment of the present invention.

FIG. 3 is a schematic representation from one side of a mobile washer for washing with a door open in accordance with a preferred embodiment of the present invention;

FIG. 4 is a schematic representation of a side view of an internal washing chamber in vertical cross-section of the mobile washer for washing in accordance with a preferred embodiment of the present invention;

FIG. 5 is a schematic representation of a front end view of the representation in FIG. 4 in vertical cross-section;

FIG. 6 is a schematic representation in side perspective showing complex inter-operable parts of a mobile washer for washing a BBQ grill and/or hot plate in accordance with a preferred embodiment of the present invention

FIG. 7 is a schematic perspective representation of a mobile washer for washing a BBQ grill and/or hot plate showing complex inter-operable parts of the mobile washer in different geometric arrangement to FIG. 6

FIG. 8 is a schematic perspective representation in part side elevation of a further array of elements and inter-operability in a mobile washer for washing and cleaning a BBQ grill and/or hot plate after use;

FIG. 9 is a schematic perspective representation of FIG. 8 showing a first condition of use;

FIG. 10 is a schematic perspective representation of FIG. 8 showing a second condition of use;

FIG. 11 is a schematic perspective representation of FIG. 8 showing a third cleaned condition of use;

FIG. 12 is a schematic perspective representation from front and part side elevation of a mobile washer in accordance with a further preferred embodiment of the present invention;

FIG. 13 is a schematic perspective representation of FIG. 12 from rear and part side elevation;

FIG. 14 is a schematic perspective representation from front and part side elevation of the embodiment in FIG. 12;

FIG. 15 is a schematic perspective representation of assembly elements of the mobile washer in accordance with FIG. 12;

FIG. 16 is a schematic representation of the washing apparatus of FIG. 12 including assembly in FIG. 15 in vertical cross-section showing assembly and operation of foaming projection onto grill plates;

FIG. 17 is a schematic representation of the assembly in FIG. 15 from a top view showing operation of foaming projection onto grill plates;

FIG. 18 is a schematic representation of the assembly in FIG. 15 from a front perspective showing operation of foaming projection onto grill plates;

FIG. 19 is a schematic representation of the assembly in FIG. 15 from a side perspective showing operation of foaming projection onto grill plates;

FIG. 20 is a flow diagram showing interaction between a plurality of elements of the mobile washer of the invention for washing and cleaning a BBQ grill and/or hot plate;

FIG. 21 is a flow diagram showing further complex interactions between a plurality of elements of the mobile washer of the invention for washing and cleaning a BBQ grill and/or hot plate in accordance with a further embodiment of the invention;

FIG. 22 is a flow diagram showing interaction of control systems of the mobile washer of the invention for washing and cleaning a BBQ grill and/or hot plate in accordance with a further embodiment of the invention;

FIG. 23 is a further flow diagram showing further complex interactions between a plurality of elements of the mobile washer of the invention for washing and cleaning a BBQ grill and/or hot plate in accordance with a further embodiment of the invention;

FIG. 24 is a schematic representation in partial side elevation of a further preferred embodiment in accordance with the present invention;

FIG. 25 is a schematic representation of FIG. 24 from rear;

FIG. 26 is a schematic representation of FIG. 24 from front partial side elevation in open condition with sample grill;

FIG. 27 is a schematic representation of FIG. 26 from front partial side elevation in open condition with sample grill in holder in forward position;

FIG. 28 is a schematic representation of FIG. 26 from opposing front partial side elevation in open condition with sample grill in forward position;

FIG. 29 is a schematic representation of FIG. 26 from opposing front partial side elevation in open condition with sample grill within wash housing;

FIG. 30 is a schematic representation of FIG. 28 from rear and partial side elevation in open condition with rear cut-out;

FIG. 31 is a schematic representation of FIG. 30 from front partial side elevation in part open condition with rear cut out;

FIG. 32 is a schematic representation of FIG. 31 from front partial side elevation in open condition with cut out side and rear;

FIG. 33 is a schematic representation of a further preferred embodiment in accordance with the present invention showing a cartridge for engagement with front end of washer;

FIG. 34 is a schematic representation of a heavy duty washing machine in accordance with the present invention showing close up view of foam and rinse injector system;

FIG. 35 is a schematic representation of a heavy duty washing machine in accordance with the present invention showing heating element and outlet;

FIG. 36 is a schematic representation of one embodiment of the present invention with cut-outs showing internal mechanisms and flows;

FIG. 37 is a schematic representation of the invention showing rinsing cycle inside washing chamber rinsing a grill; and

FIG. 38 is a schematic representation of the invention showing foam cycle and spray over grill within washing chamber.

### DESCRIPTION OF PREFERRED EMBODIMENTS

It should be noted in the following description that like or the same reference numerals in different embodiments denote the same or similar features.

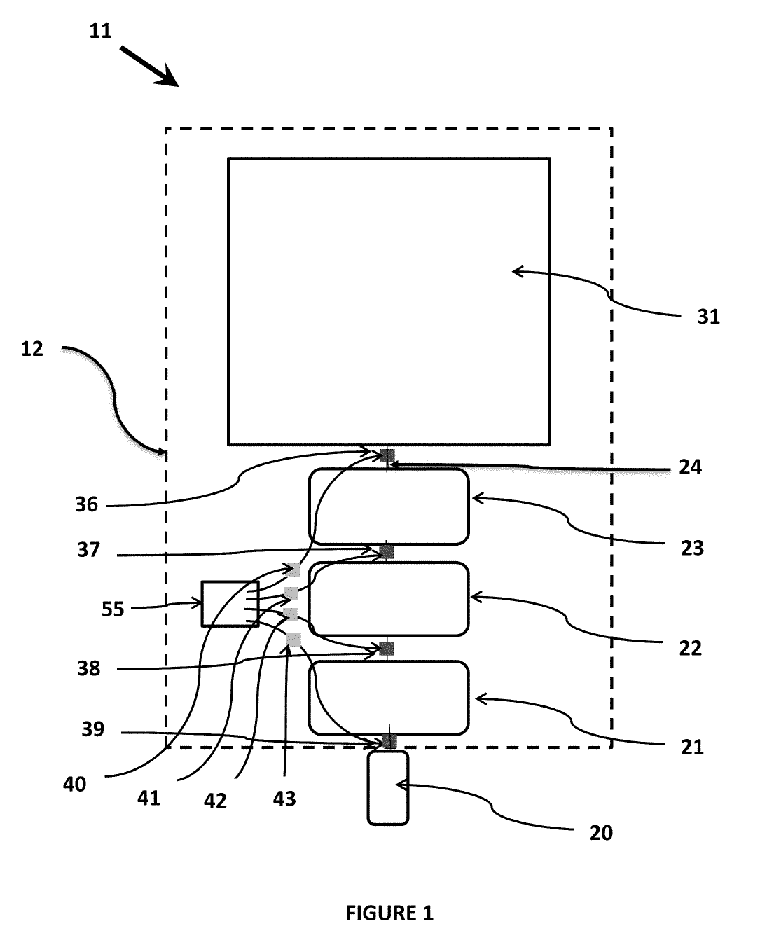

Referring to FIG. 1 there is shown a schematic heavy duty washing apparatus 11 for cleaning cooking substrates including hotplates and grills. The apparatus 11 includes a mobile housing 12 having an inlet 20 connectable to a water supply, the mobile housing providing a washing compartment 31, and a plurality of intermediate conditioning stations 21, 22 and 23 for conditioning a supply of water for use in the washing compartment.

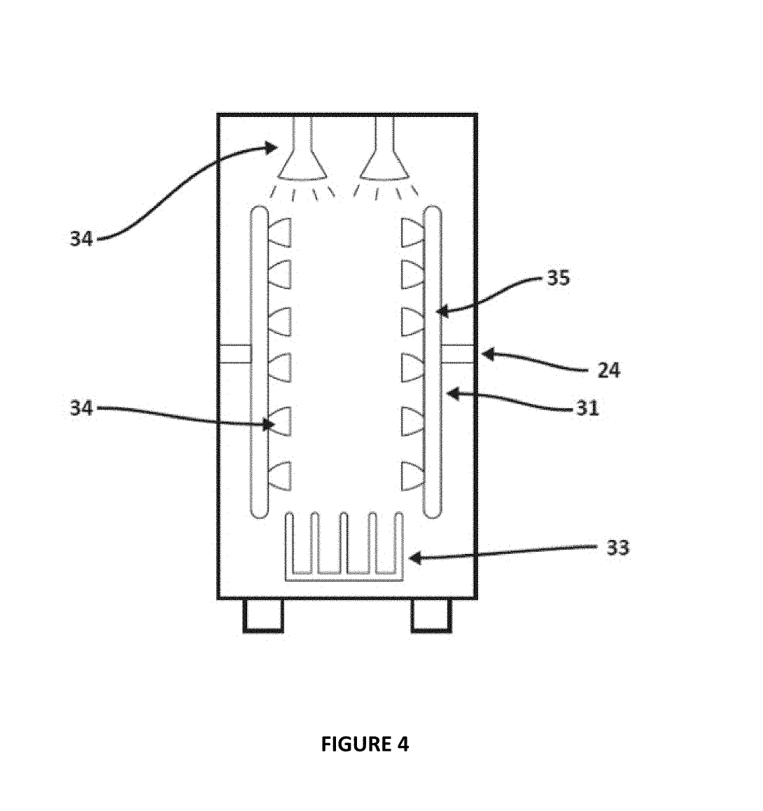

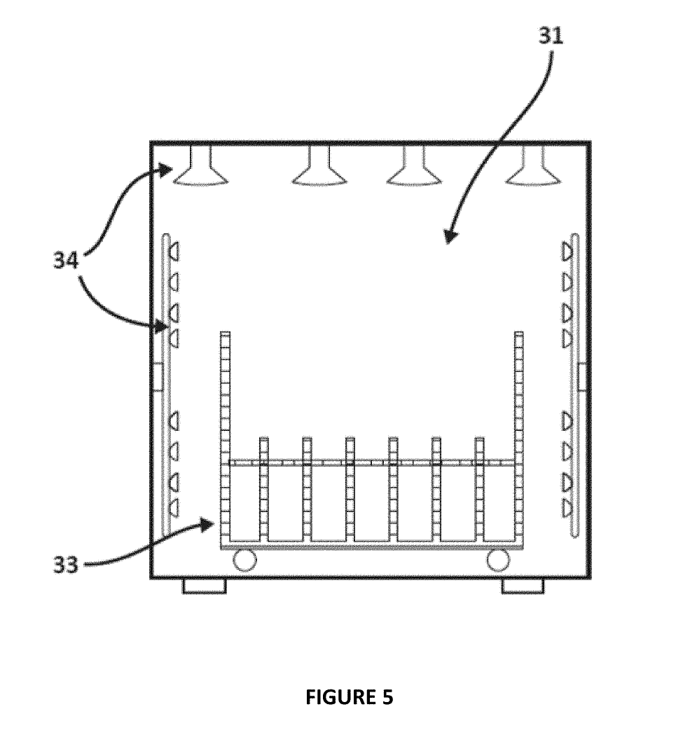

The washing compartment 31 (shown in FIGS. 4 and 5) has a pull out draw enclosure 32, which can operate hydraulically (not shown) or slidably (as shown in FIG. 3) along internal tracks or rails (not shown), and includes a hotplate, grill or other substrate receiving facility 33. The washing compartment as shown in FIGS. 4 and 5 further includes an array of spray heads 34 mounted to side wall and roof portions of the compartment, and conditioned water or fluid directed into the chamber through the spray heads.

The conditioning stations 21, 22 and 23 include a pressurising station and a temperature conditioning station, these stations receiving water downstream from the inlet 20 whereby the stations provide a high pressure and high temperature conditioning to a predetermined select temperature and pressure before flow to the washing compartment through an inlet 24 of the washing compartment.

In FIGS. 4 and 5 the washing compartment includes an inlet manifold 35 sub-assembly intermediate the inlet 24 and spray heads 34 for transporting conditioned water from the inlet 24 to the array of spray heads located within the washing compartment. The spray heads are adjustable to alter the direction of spray, and a control means (not shown) can adjust operation of select spray heads.

As shown in FIG. 1, the mobile heavy duty washing apparatus further includes an integrated application processor 55 in operational communication with an array of sensors 36, 37, 38 and 39 for controlling conditions at the conditioning stations 21, 22 and 23. The sensors 36, 37, 38 and 39 are located at or close to the conditioning stations and communicate with the application processor 55 via sensor processor units 40, 41, 42 and 43. The application processor 55 allows an operator to preselect washing conditions including temperature, pressure, inflows of water, detergent, chemicals, and cycles and residence timing.

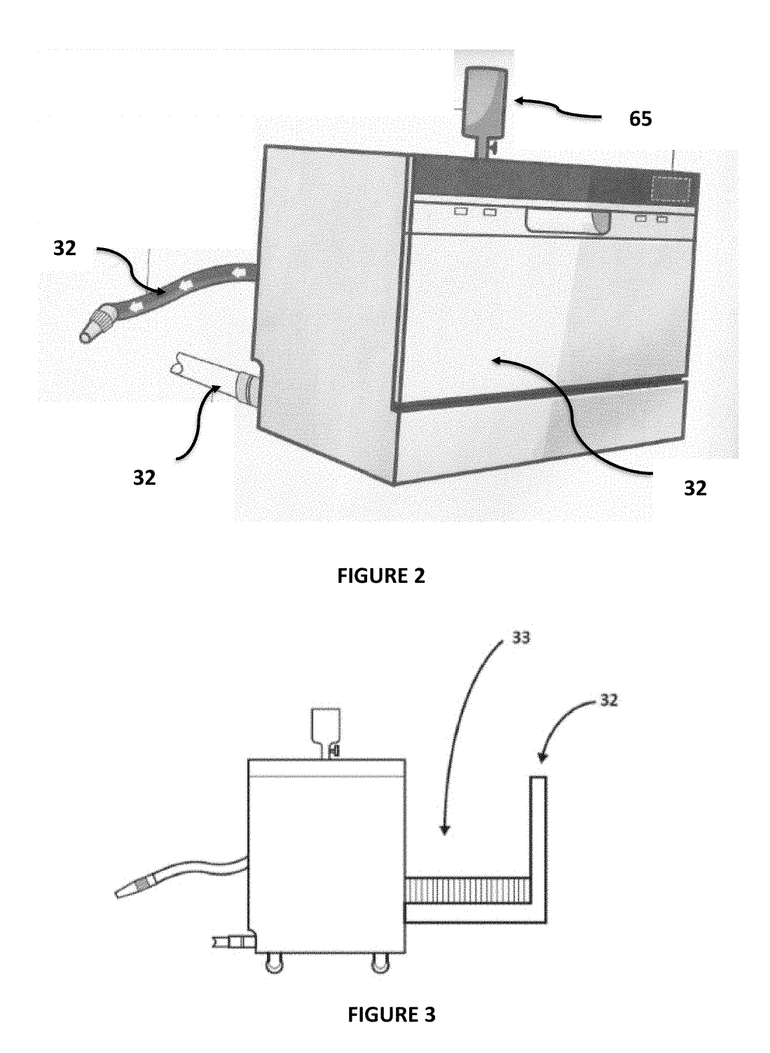

In one embodiment shown in FIGS. 2, and 6 to 11, the washing apparatus further includes a means 65 for introducing a fluid or chemical under pressure to the washing compartment. In this embodiment, the housing is structured to include a cavity adapted for receiving a high pressure canister 65, the canister holding a reservoir of a chemical foaming agent. The housing further comprises an engagement means in the cavity interconnecting an outlet of the canister to the washing compartment for introducing the chemical foam. The chemical foaming agent is triggered to introduce a fluid under pressure, and forms a foam layer on contact with surfaces in the washing compartment including hot plates and grills and accessories.

It is understood that the sensors at various conditioning stations send information to the application processor, and preselect conditions managed by the processor. The control of variables such as temperature, pressure, timing and the like allows an operator to control residues on plates. Heavy cooking residues may for example take longer and require exposure to chemicals and pre-soaking for substantial periods to significantly reduce residues of grease, fats, oils and foods from a cooking surface.

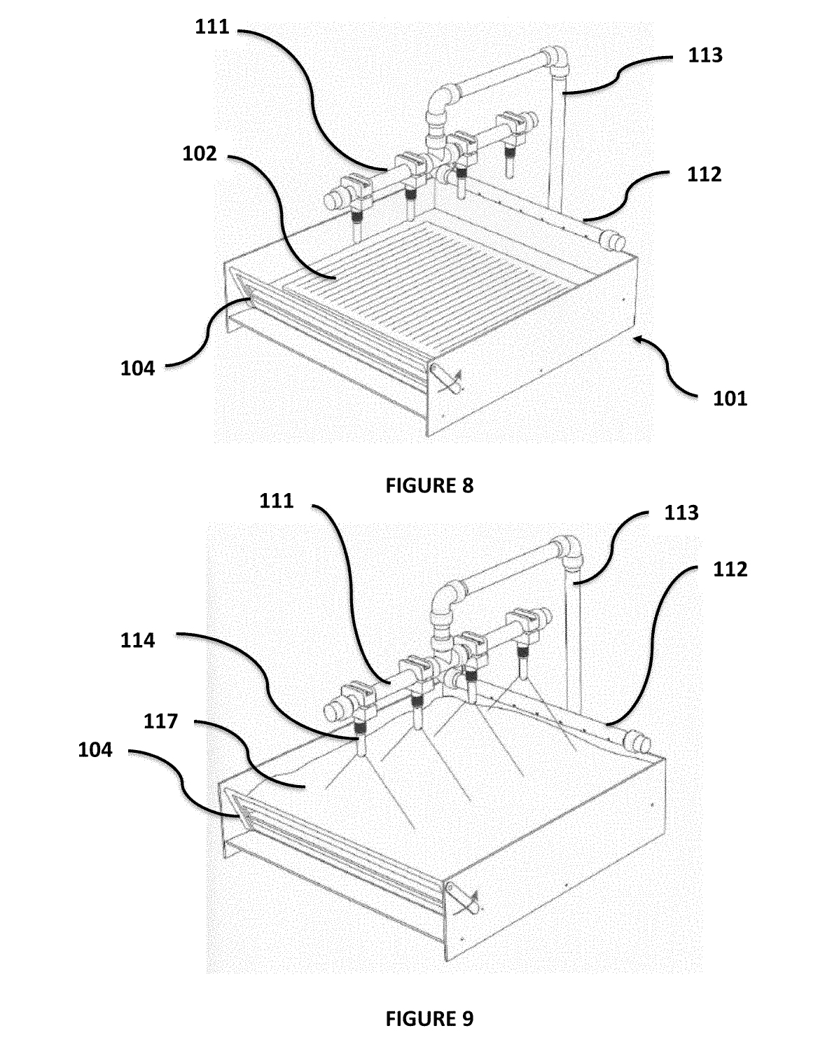

As shown in FIG. 8 there is disclosed a method and process of washing cooking substrates including hotplates and grills, including providing a unit with heavy duty washing apparatus comprising a mobile housing having a plurality of interconnected stations within the housing for conditioning a supply of water, the stations including a pressurising station and a temperature conditioning station; and a washing compartment within the housing interconnected downstream from the conditioning stations, the washing compartment adapted to receive one or more of the cooking substrates in a stackable array. The method comprises connecting the washing apparatus to a water supply feeding to the conditioning stations; wherein the stations provide a high pressure and high temperature cleaning to the cooking substrates in the washing compartment.

The conditioning stations include temperature and pressure modules which are operated by a central processor to vary preselected temperature and pressure conditions. The method also comprises a plurality of preselected cycles including water temperature, pressure, soaking, time, and volume of water in the washing compartment. The apparatus can include a series of sensors and a central processor in communication with the sensors so that preselected cycles and conditions can be pre-programmed and monitored so that energy can be conserved and preselect conditions substantially maintained.

As shown, the method also includes introducing a select volume of preconditioned water in the washing compartment via an array of inlets, and allowing the volume of preconditioned water to remain in contact with cooking substrates in the washing compartment for a preselect period of time.

In one preferred form, the method can include providing a canister 150 containing a chemical cleaning agent, whereby the canister is loaded into a dedicated inlet assembly on the mobile housing, wherein the inlet assembly is interconnectable to the washing compartment and actuates the canister for transporting and introducing pressurized fluid from the canister into the washing compartment, wherein the fluid forms a foam layer on contact with a surface to be cleaned. The foam layer can be allowed to remain on the contact surfaces for a preselect period of time. The method can further include introduction of conditioned water to remove chemically reacted residues, and/or surfactants to further solubilize greases and other built-up foods, before rinsing or further soaking with high temperature water. Alternatively, the chemically treated residues can be exposed to high pressure and high temperature conditioned water to assist removal of grease, fat, and other combinations of foods and oleaginous material build up.

As indicated in the method of washing cooking substrates such as hotplates and grills, a heavy duty washing apparatus comprises a mobile housing including a motor; a plurality of interconnected stations within the housing for conditioning a supply of water, the stations including associated temperature and pressure modules for said conditioning of temperature and/or pressure; a washing compartment within the housing interconnected downstream from the conditioning stations, the washing compartment adapted to receive one or more of the cooking substrates in a stackable array, wherein the washing compartment includes a series of inlets and internal non-corrosive liner; a series of sensors located at or close to the conditioning stations and washing department to monitor conditioning and washing parameters, a central processor in operating communication with the sensors to receive input data from the sensors and operate the modules of the conditioning stations, a chemical station in the housing and fluid injection system for transferring a chemical in a fluid form from the receiving platform to the washing compartment, and a pressurised canister containing a chemical cleaning agent composition. The method includes connecting the washing apparatus to a water supply feeding to the conditioning stations wherein the stations provide a high pressure and high temperature cleaning to the cooking substrates in the washing compartment, and wherein the method further includes introducing chemical in a fluid form from the canister into the washing compartment whereby a foam layer if formed on contact with cooking surfaces to be cleaned. In a preselect condition, the foam layer is retained on the substrates for a predetermined period time, followed by a programmed rinsing of the foam layer with preselected conditioned high temperature and/or pressurised water to remove chemical and food residues.

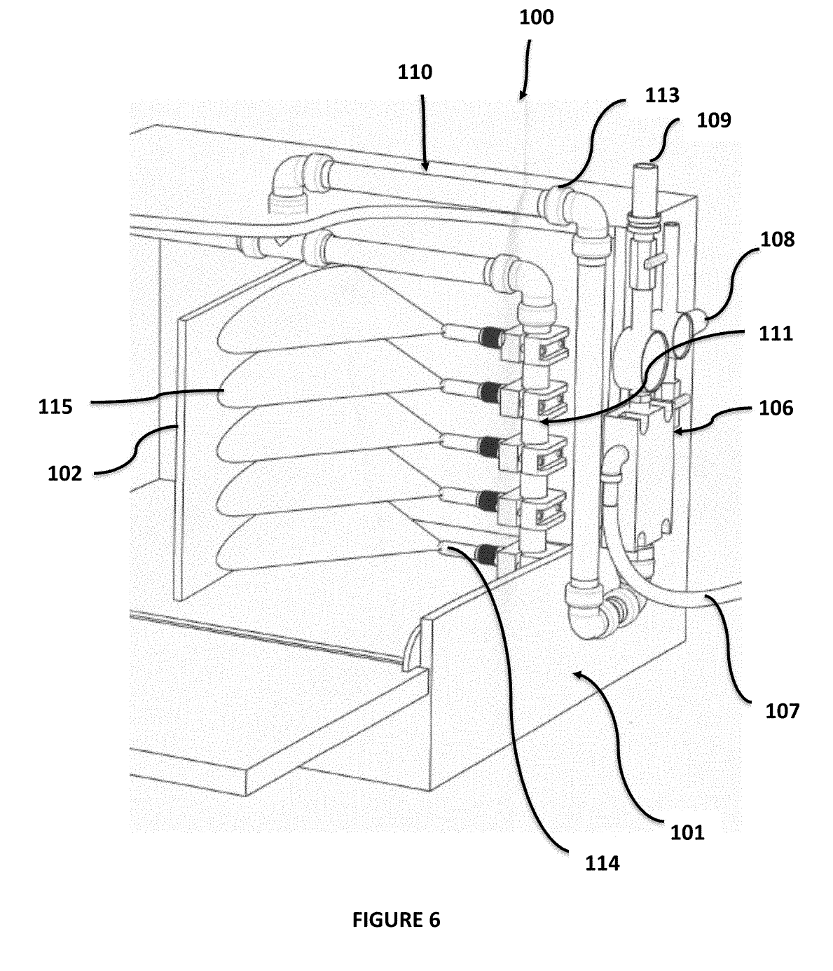

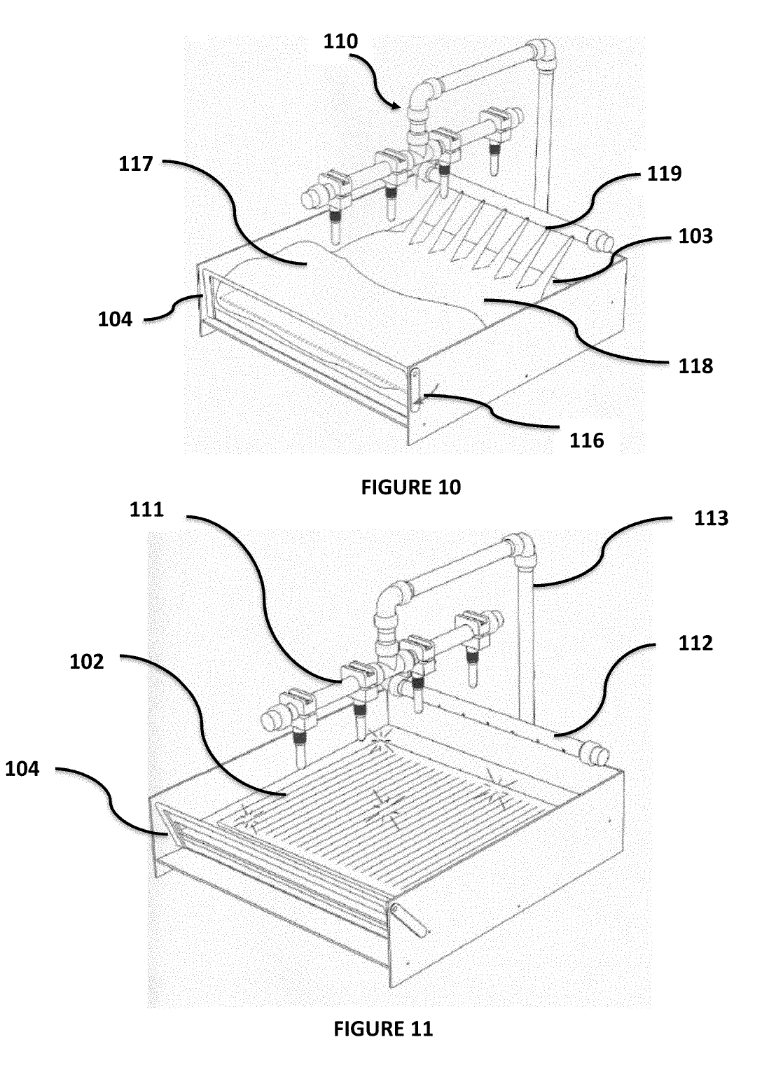

Referring particularly to FIGS. 6 to 11, there is shown a chamber structure 100 forming part of the washing apparatus, the chamber 100 comprising a base 101, which is adapted to receive one or more grill plates or hot plates 102 for cleaning following use. The base 101 is divided into a grill plate or hot plate receiving portion 103 and a sump portion (not shown) beneath the grill plate receiving portion. The grill plate receiving portion and sump portion define a flow pathway for fluid or foam or water to an outlet in the sump. The flow of fluid between the grill plate receiving portion 103 and the sump is controlled by an adjustable closure 104. In the embodiment shown, the closure 104 is operable between a closed position (see FIG. 9) and an open position shown in FIG. 10 by a lever 105 which can be operated by electronic switching through the processor 55.

The chamber structure further includes a foaming system 106 mounted to the chamber and interconnected to a reservoir of a concentrate cleaning composition (not shown) by a conduit 107. The foaming system 106 uses incoming domestic water pressure through inlet port 108 to assist drawing the cleaning concentrate from the reservoir and combine with a water stream. The rate of incoming water supply can be controlled by the processor 55 to provide a predetermined diluted concentration of the cleaning solution. The foaming system further includes an inlet port 109 for introduction of a source of compressed air (not shown). In operation, the compressed air is injected into the cleaning solution to generate a foam having a range of predetermined characteristics defined by foam density, viscosity, and adhesiveness. Depending on the extent of cleaning required, the concentration of cleaning solution and physical characteristics can be adjusted.

The chamber structure further includes a cleaning sub-assembly 110 comprising a foaming manifold 111 and a rinsing manifold 112 interconnected to the foaming system 106 downstream therefrom by conduit 113. The sub-assembly includes a control system (not shown) which controls flow of cleaning fluid and water into the grill receiving portion of the base 101.

The foaming manifold 111 includes an array of spray nozzles 114 spaced apart which in operation as shown in FIGS. 6, 7 and 9 project a fanned foam 115 of cleaning composition onto a surface of the soiled grill plate 102, the plurality of nozzles enabling a full surface of the soiled grill plate to be contacted by the foamed cleaning composition.

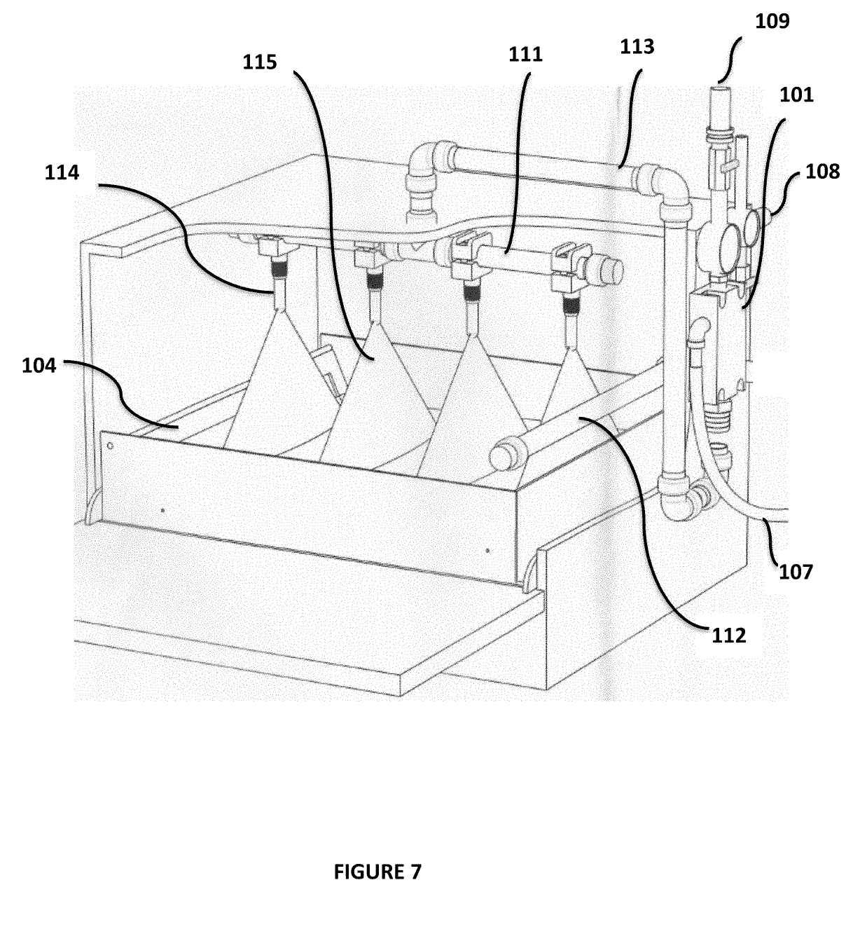

FIGS. 6 and 7 show different orientations of the foaming manifold such that FIG. 6 shows a vertical orientation allowing projection of foamed composition in a horizontal direction onto the grill plate. Alternatively, FIG. 7 shows a horizontal foamed manifold orientation projecting foamed cleaning composition in a vertical direction onto the grill plate. In addition, these embodiments show the foam manifold and rinse manifold at substantially right angles to each other.

The rinsing manifold 112 of the cleaning sub-assembly includes a series of spaced apart openings for egress of water. The rinsing manifold is interconnected to the water inlet 108 of the foaming system and operable in a rinsing condition to receive water from the foaming system and direct a front 118 of water from the spaced apart openings 119.

Referring to FIGS. 7 to 10, there is shown stepwise cleaning operation of a soiled grill plate. In the first instance as shown in FIG. 8, a soiled grill plate 102 is placed in the grill plate receiving portion of the base 101. In this condition, the closure 104 is initially arranged automatically by an actuator 116 to close the fluid pathway between the grill plate receiving portion of the base and the sump therebelow.

Next operation of the washing apparatus is shown in FIGS. 6, 7 and 9. In this step of the cleaning process, a head of foam 117 is formed in the grill plate receiving portion of the base by projecting foamed cleaning composition through the foaming manifold 111 and spray nozzles 114 onto the soiled grill plate. The foam cleaning composition is thereby confined by the grill plate receiving portion of the base and the closure 104. The volume and therefore level of foamed composition in the grill plate receiving portion is controlled by a volume sensor in the chamber, and the volume able to be replenished with fresh supply of cleaning foam if the volume of foam is detected below a predetermined value. Therefore in the case of a heavily soiled plate, the plate can be continuously immersed for a given predetermined cycle of time.

The amount of time in contact with the soiled grill plate is controlled by a timing control system which communicates with the volume sensor and the actuator switch 116 for opening and closing of the closure 104. In a closed position as shown in FIGS. 8 and 9 the soiled grill plate may be maintained in contact with the foamed cleaning composition for a predetermined period. The time in contact with cleaning foam composition may vary from 15 to 45 minutes and may be cyclical. Alternatively, the contact period may be alternated with rinsing and reapplication with a head of foam composition.

Referring to FIG. 10, once the predetermined contact time between soiled plate and cleaning foam is complete, the closure 116 is actuated to an open position thereby providing a continuous fluid pathway between the grill plate receiving portion and the sump. A rinsing cycle is initiated when the closure is opened, prompting ingress of water into the grill plate receiving portion of the base by the rinsing manifold 112. As shown, the ingress of water forms a moving front of water 118 which urges displacement of the foam composition along the fluid pathway to the sump and outlet. In order to assist this transition of foam between the grill plate receiving portion and the sump, the base is inclined towards the sump to promote drainage. In one embodiment the rate of flow of the rinsing water can be adjusted and nozzles oriented such that incoming water may be pressurized and directed on to the grill plate so as to assist removal of residues at the same time as displacing the foam.

In one embodiment, the soiled grill plate may be subjected to initial heating to prime the surface and residues to treatment with the cleaning foam composition.

FIG. 11 shows the end product of the process of washing in which residue on the grill plate is removed. In a further embodiment (not shown), the base 101 of the chamber 100 is adapted to move into a washing position in the chamber by a track means, and be automatically or manually moved away from the washing location in the chamber to allow removal and replacement of the washed grill. In a further embodiment, the base 101 or chamber 100 is configured to accommodate the foam system and cleaning concentrate in a forward location, to enable easy access to these components for cleaning and replenishment.

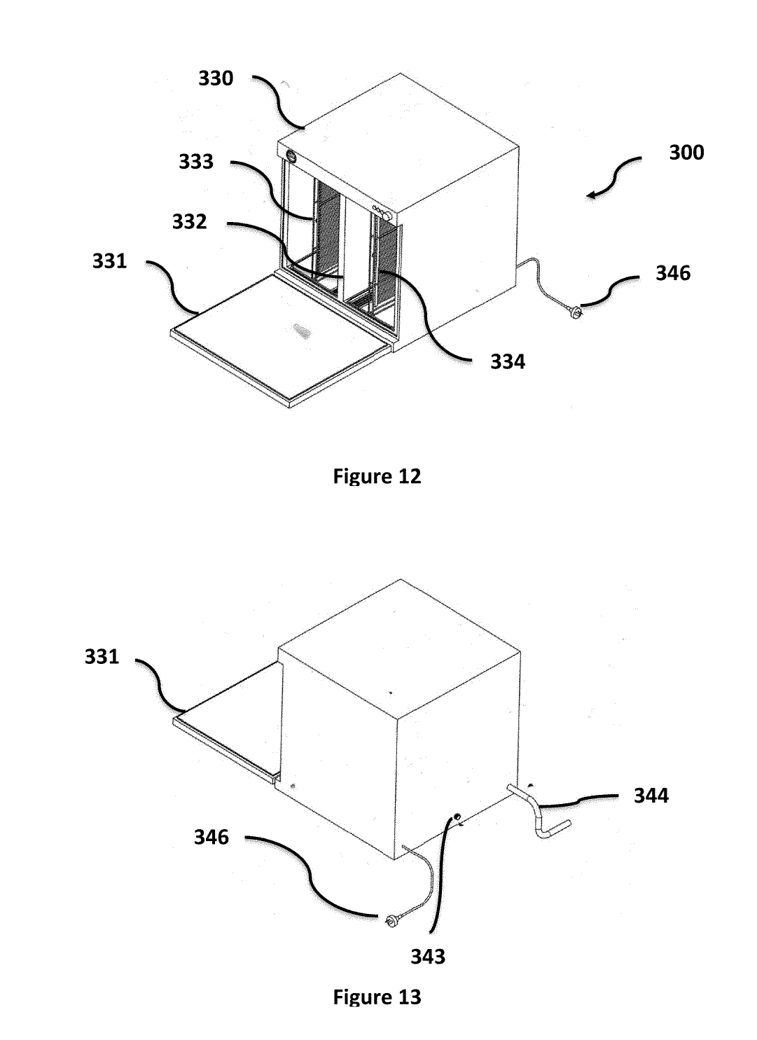

Referring to FIGS. 12 to 15, there is shown a further embodiment of the mobile washing apparatus showing a chamber 300, forming part of the washing apparatus, comprising five walls 330 and a closure 331. The chamber further comprising at least one partition wall 332 separating the chamber into multi compartments adapted to receive soiled grill plates or hot plates 333 and 334 for cleaning in a vertical orientation. In this embodiment, the foam and rinse manifold are configured in parallel.

The walls 330 of the chamber 300 and at least one partition wall 332 include a foam manifold 335 and a rinsing manifold disposed therein for projecting a foamed cleaning composition onto the surface of the grill or hot plates. In this embodiment, a canister 337 carrying a fluid cleaning composition, is inserted into a mounting port 338 on an external portion of the chamber for engagement with an internal trigger or actuator in the mounting port, to initiate release of the cleaning fluid into a foam generating system 339. In an operating condition, the cleaning fluid is in the form of a concentrate, which is drawn into a foam generating system 339 upstream from the foam manifold 335. The foam generating system 339 as previously described introduces a supply of water and compressed air to mix with a volume of the cleaning concentrate to provide a predetermined cleaning concentration, and foam adhesiveness properties characterised by maintaining contact with the grill plate for a period of between about 15 to 30 minutes for reaction with food residues including fats, grease, oils and proteins.

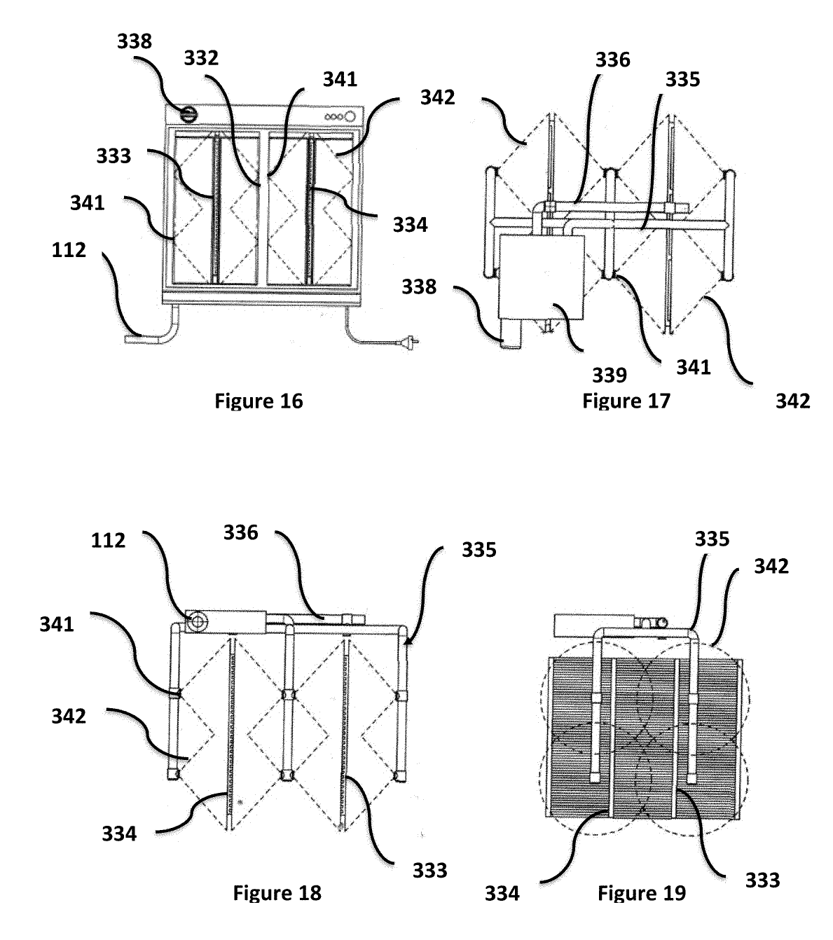

The foam manifold comprises an array of interconnected conduits received within the confines of the chamber walls and partition walls, with nozzles 341 provided in spaced apart relation in the conduits and located in the walls and partition structure of the chamber to allow projection of foam onto and over all surface area of the grill plates in a plurality of compartments. As seen in FIGS. 16 to 19, the spray projection 342 is mapped showing regions of spray projected from the spray nozzles overlapping and covering all exposed surfaces of the grill plates. In this embodiment, two grill plates are arranged in adjacent compartments and foam generated by the foaming system pumped through the foam manifold for egress through the spray nozzles under pressure. The pressure of exiting foam spray can be adjusted by the nozzles to increase spraying pressure and region.

In one embodiment, the chamber is subjected to preliminary heating to assist reaction between the food residues and cleaning foam composition projected thereon.

Once an initial predetermined reaction period has expired, the resultant reactant foam and food residue is subjected to a high pressure water rinse by the rinse manifold. In this step, water supply to the water supply inlet 343 is directed to the rinse manifold 336 which projects water from spray jets in the rinse manifold onto the grills to displace foam towards a drainage sump and to the drain 344.

The chamber includes a processor control and control panel 345 connected to a power source 346, and an operating circuitry in communication with the processor control. The processor control is adapted to control operation of the foam generator system, foam and rinse manifold, base closure, concentration of cleaning composition, and exposure time for foam contact and cycles.

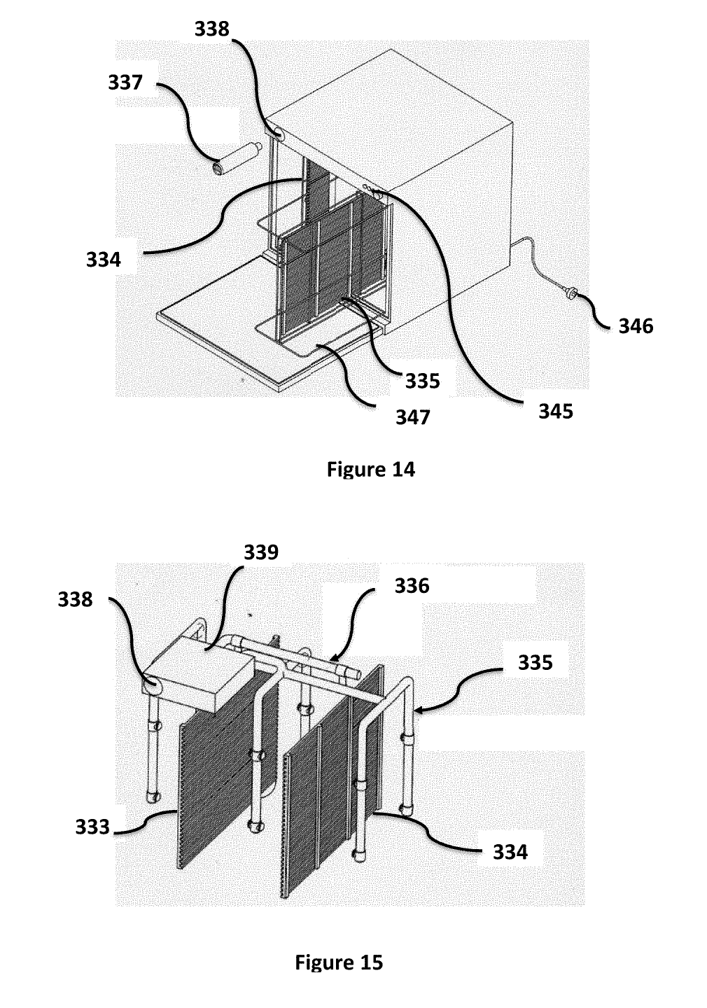

As shown in FIG. 14, the grill plates are loaded onto sliding racks 347, which slide on mating track and rails

In a further embodiment, the cleaning foam composition is selected from alkaline or caustic materials, or combinations of such materials and chlorine and surfactants.

TABLE 1
Foaming Tests for soiled grill
Using chemical composition comprising:-
2-Butoxyethanol 1-10%
Surfactants 10-30%
Disodium metasilicate 1-5%
Sodium hydroxide less than 1%
Solvent balance
pH-13.4 neat form Highly alkaline

| Test | Procedure | Result |
|---|---|---|
| F1 | A25 airless foam | Low foam creation and |
| | nozzle at close | generally air pressure |
| | distance at high | blew off the foam |
| | pressure | |
| F2 | 5025 air foam | Pressure too high at close |
| | nozzle | distance-difficulty in |
| | | confined volume chamber |
| F3 | 50 compressed air | found too difficult to create |
| | nozzle | good foam as it required |
| | | air adjustment |
| F4 | 4 X Bullet Nozzles- | Good foam coverage of |
| | Low pressure | grill-baked on grease |
| | | however will not rinse off |
| | | under standard water |
| | | pressure. |

TABLE 2
Combined General-Foaming using low pressure-Chemical Testing

| Test | Procedure | Result |
|---|---|---|
| GFC1 | Composition 1 comprises: | Application under low pressure |
| | 2-Butoxyethanol 1-10% | creates good foam characteristics |
| | Surfactants 10-30% | however not good cleaning as |
| | Disodium metasilicate 1-5% | baked on grease will not rinse |
| | Sodium hydroxide less than 1% | off under standard water pressure |
| | Solvent balance | |
| GFC2 | Composition 2- | Product composition remained |
| | 125 ml of Composition A | on grill for 20 mins; |
| | containing 6% w/w KOH; | Foam consistency 60%-good; |
| | 6% w/w NaOH; balance H₂O | Product effectiveness-50% |
| | (pH-13.0); and 125 ml H₂O | moderate; Good fat emulsification |
| | | as dissolved fats rinsed off with |
| | | cold water |
| GFC3 | Composition 3- | penetration into baked on |
| | 100 mls of a composition B | proteins and marinades very |
| | comprising: less than 10% w/w | well 75%, |
| | Hypochlorous Acid Na salt; less | Foam consistency 85% due |
| | than 10% w/w NaOH balance | to its high foam ability and its |
| | H₂O (-pH-greater than 12); and | very high performance to |
| | 100 mls of water. Apply | remove fats, oils and proteins |
| | Composition 3 using a 500 ml | from grills plus substrates and |
| | pump spray with mesh filter- | provides complete sanitation |
| | composition 3 applied six times | to the surfaces. |
| | with six minutes intervals. | |
| | Ambient conditions warm so we | |
| | were able to the ambient | |
| | temperature to slightly warm the | |
| | grill before application and the | |
| | final rinse with cold water. | |
| GFC4 | Composition 4- | Grill slightly pre-warmed in |
| | mixing 100 mls of a composition | ambient temperature. The |
| | C containing: 10-30% w/w | cleaning penetrations into the |
| | NaOH; less than 10% w/w | proteins was very good 85% |
| | sodium gluconate; and less than | The foaming quality was low |
| | 10% w/w surfactant; and 100 mls | 45% |
| | of water | 50% due to its caustic |
| | Composition 4 applied using | application. Really liked the |
| | the same dispenser as GFC3 | product due to its liquid scouring |
| | with six minutes intervals. | effect on the baked-on grease/ |
| | | carbon oils and fats and its low |
| | | odour and has no acids plus its |
| | | 100% fire proof also |
| | | biodegradable. |
| | | Overall good cleaning |
| | | penetration into proteins but |
| | | poor foaming capability. |
| GFC5 | Composition 5- | results were brilliant it looked |
| | mixed 100 mls of composition | brand new |
| | B, 100 mls of composition C, | Great foam 95% |
| | and 200 mls of water. | Cleanability 99% |
| | Repeated application at six | |
| | minute intervals for six | |
| | applications, but instead of | |
| | rinsing with cold water grills | |
| | were placed into a domestic | |
| | dishwasher on a 20-minute glass | |
| | cycle wash for final hot wash. | |

Referring to Tables 1 and 2, a range of trials were performed by the applicant to determine a suitable cleaning composition for the present purposes. As a starting point, for heavily soiled grills it was one objective of the present invention to derive a cleaning protocol that exhibited the following characteristics including:
a. effectiveness to dissolve or react with a range of material deposited on a grill following usual cooking of foods including proteins—meats, chicken, pork, sausages, vegetables, marinades, fats, oils, burnt food;
b. coverage of cleaning composition on and ability to remain in contact with a soiled grill;
c. sufficient time in contact with soiled grill of about 30 minutes;
d. foaming characteristics of cleaning composition; and
e. use in confined volumes as per washing chamber.

A range of parameters were tested as per Tables 1 to 4 including pressure delivery of cleaning composition, chemical cleaning effectiveness, and foaming characteristics.

In a first composition (refer Table 1), the applicant has used a cleaning composition comprising:
2-Butoxyethanol 1-10w/w %
Surfactants 10-30w/w %
Disodium metasilicate 1-5w/w %
Sodium hydroxide less than 1 w/w %
Solvent balance

In a first application, a known ‘lafferty’ mixing unit was used to combine predetermined quantities of the first cleaning composition, air and water, and to test airless foam and compressed air foam and a standardised amount of the cleaning composition applied to a soiled grill. A range of nozzle configurations were used to deliver a predetermined amount of the combined product onto the soiled grill in an open condition including:
an A25 airless foam nozzle;
a 5025 compressed air nozzle;
4×50 Compressed air nozzles; and
4×bullet airless foam nozzles—low pressure.

Applicant found that higher pressure delivery nozzles either had difficulty creating a foam or the cleaning composition was applied at too high a pressure to an extent that a majority of the composition did not contact the grill surface, i.e., passed through grill openings or was caused to be removed. Higher pressures however are not suitable for use in confined volume chambers.

Applicant found that best results achieved using low pressure bullet airless nozzles producing a foam from the first cleaning composition that adheres to the grill sufficiently to allow continuous surface contact for at least 30 minutes. However, applicant found that the first cleaning composition was not effective in cleaning a soiled grill regardless of whether the foam was sufficient to adhere to the grill for at least 30 minutes. End result of optimum foam adherence with cleaning composition 1 is that baked on grease will not rinse off under standard water pressure hence physical scrubbing or higher pressure nozzles may be required.

Referring to Table 2, the effectiveness of the clean is tested in a final rinse which has been standardised using cold water. Table 2 shows that best foaming and cleaning characteristics were achieved by Composition 5 comprising composition B and composition C in a ratio of 1:1 with water such that the ratio of composition B:composition C:solvent is about 1:1:2.

In a preferred embodiment therefore, the cleaning composition includes a diluted aqueous mixture having a volume ratio of 1:1:2 of composition B:composition C:Water.

Composition B comprises:
less than 10% w/w Hypochlorous Acid Na salt;
less than 10% w/w NaOH
balance H₂O

Composition C comprises:
10-30% w/w NaOH;
less than 10% w/w sodium gluconate; and
less than 10% w/w surfactant

The applicant has surprisingly found that a combination of compositions B and C in the foregoing ratio with solvent such as water, is effective in application under low pressure conditions at short distance from a grill, to create a foam application capable of adhering to a soiled grill for at least 30 minutes to allow reaction and dissolution of food residues including fats, oils, grease, marinades and the like and to allow final rinsing in cold water to remove dissolved material.

In operation, a predetermined volume of the preferred cleaning composition concentrate (composition 5) is combined with a volume of water in a required ratio and transferred to nozzles or inlet jets in the washing chamber by the foaming system 106 to deliver a foam covering a soiled grill. The foam generated by the foaming system using the preferred cleaning composition and water mix possesses an adhesive characteristic of the foam on a soiled grill of between 15 and 30 minutes. This contact time is important to maintain effective contact and therefore reaction time between the cleaning composition and food residues on a grill plate.

The operation of the washing apparatus allows for cyclical contact between cleaning composition and grill plate in a vertical or horizontal arrangement and repeated rinsing depending on the extent of soiling.

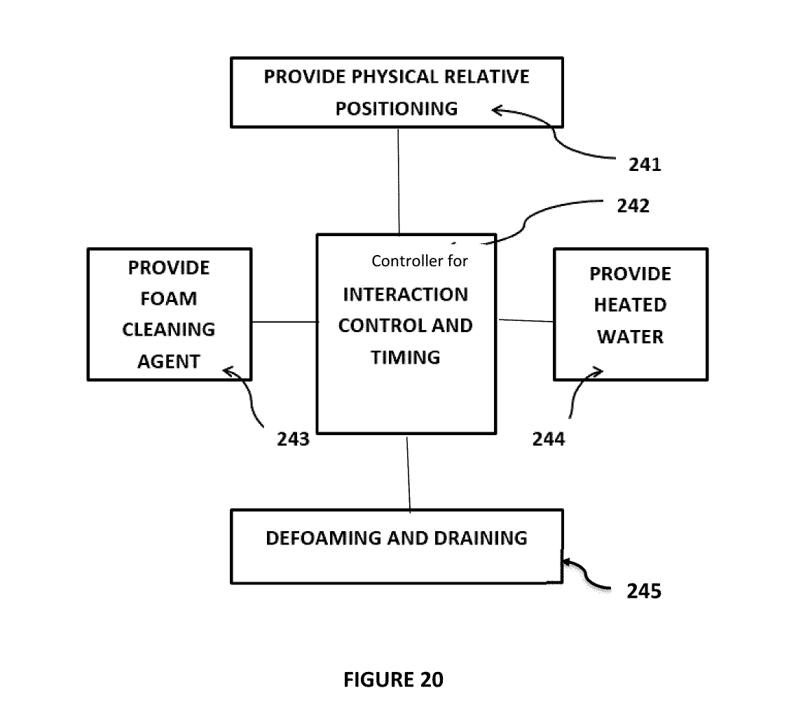

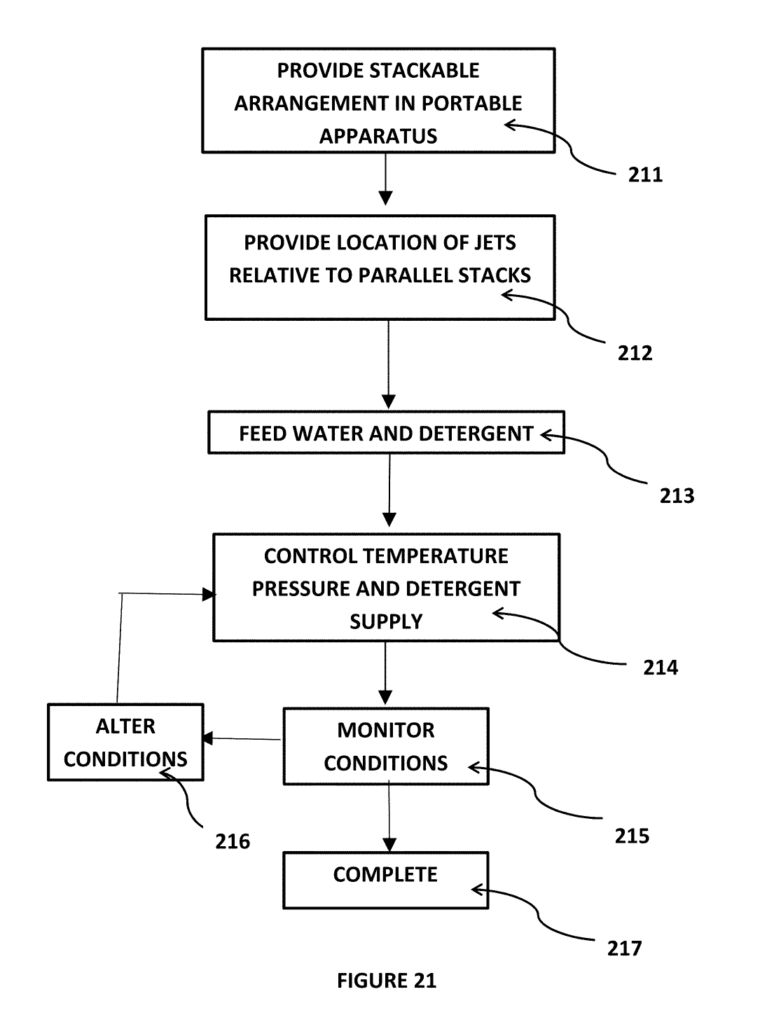

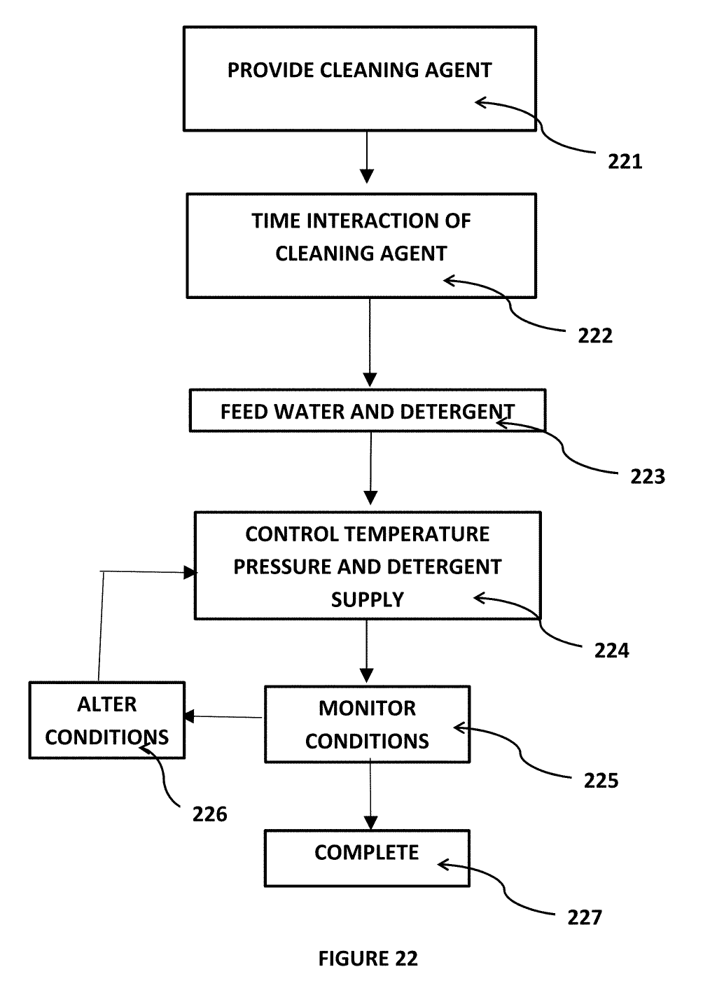

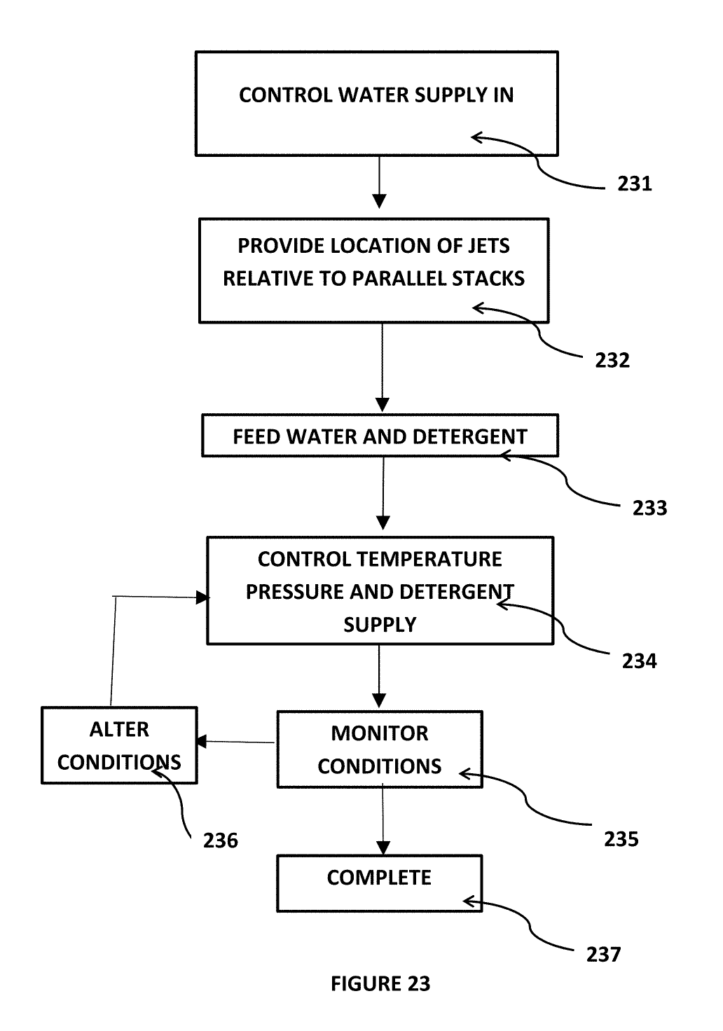

As shown in FIGS. 20 to 23, the method and process of heavy duty washing of grill plates or hot plates and the like comprises providing a mobile washing apparatus having a chamber forming part of the apparatus. The chamber having a removable washing structure comprising a washing compartment adapted to receive one or more soiled grill plates in a horizontal or vertical spaced array, and a drainage sump, the washing structure having a defined rinsing pathway for egress of foam cleaning composition between the washing compartment and drain which pathway is controllably closed and opened by a closure gate so as to maintain the volume of foam in the washing phase, and allow egress of foam. The washing chamber also includes a foam manifold (refer Fig. with a plurality of spray nozzles and a rinse manifold with water jets, the nozzles being located a distance from the grill surface to project multiple foam spray to cover all exposed grill surface.

The heavy duty washer also has a foam generating system 106 connectable to a source of compressed air 108 and a water supply 109, whereby the foam generator is interconnected to the foam manifold and rinse manifold, and operation of the manifolds is by solenoid valve to allow projection of cleaning composition in foam form in a first operation, and ingress of water from jets to displace the foam through the defined foam pathway.

As illustrated in FIG. 20, a cleaning composition according to the invention is produced by mixing a source of cleaning concentrate with a predetermined amount of water drawn by an applicator such as a foam generator 106.

In one embodiment a source of compressed air is mixed with the diluted cleaning concentrate 107 by the foam system to form a foam of predetermined concentration and foam adhesiveness. The term adhesiveness refers to the length of time the foam stays in contact with a surface of the soiled grill, i.e. longer time for protracted reaction with heavy food residues. After a predetermined time, a rinsing cycle is initiated to displace the foam. The rinsing water can be pre-heated at a preconditioning station, and incoming rinse streams are adjusted for impact velocity. At the start of the rinsing cycle, the closure gate is moved from a closed position to an open position to provide the continuous foam pathway for displacing foam with rinse to the drainage sump.

An arrangement of sensors determines timing of contact between the grill and cleaning foam, and information relayed by a control circuit to a processor. The processor controls cycle time, dilution of concentrate, rinsing cycle, conditioning pressure and temperatures, and repeat cycles.

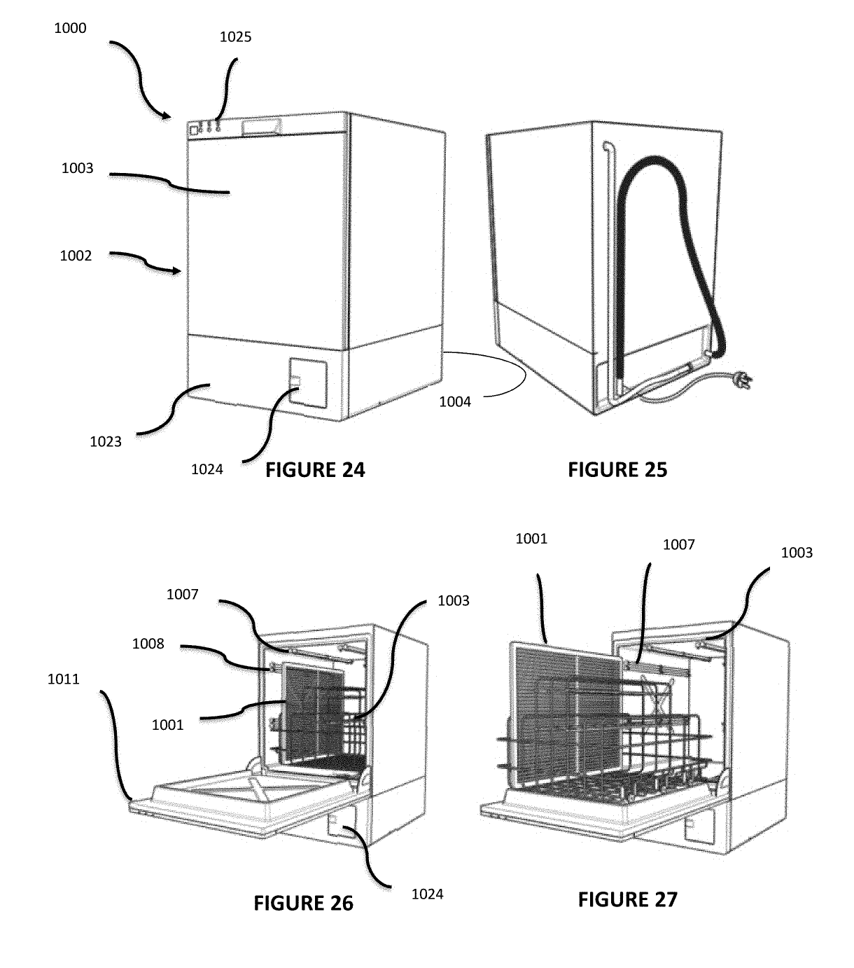

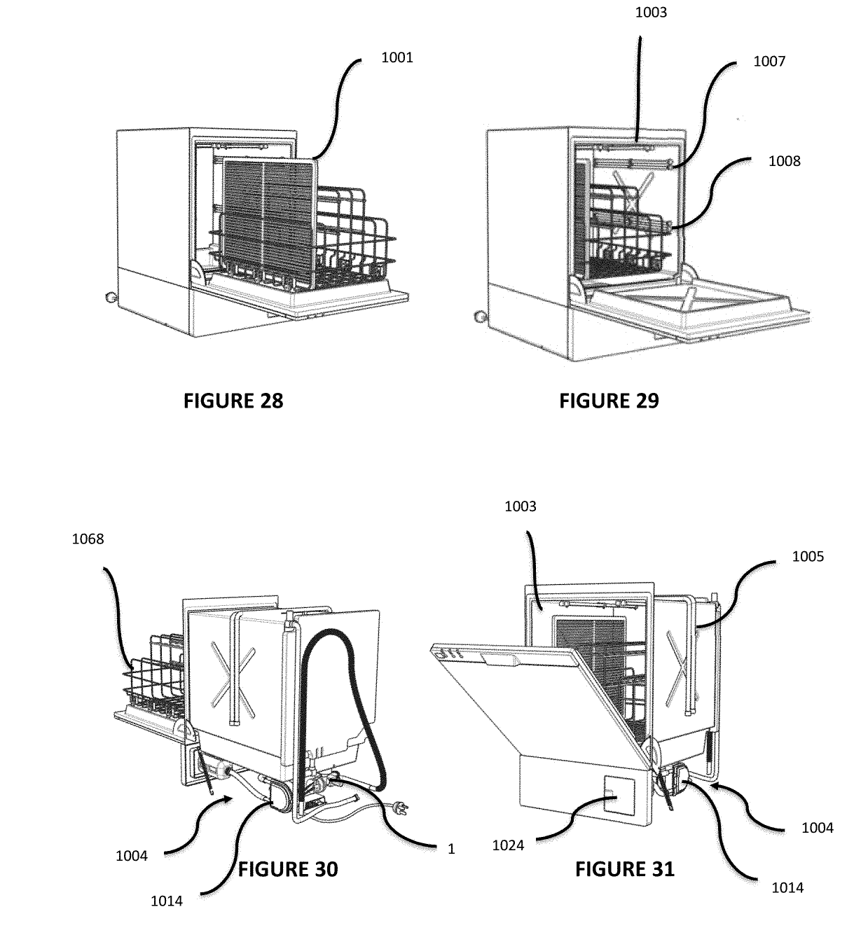

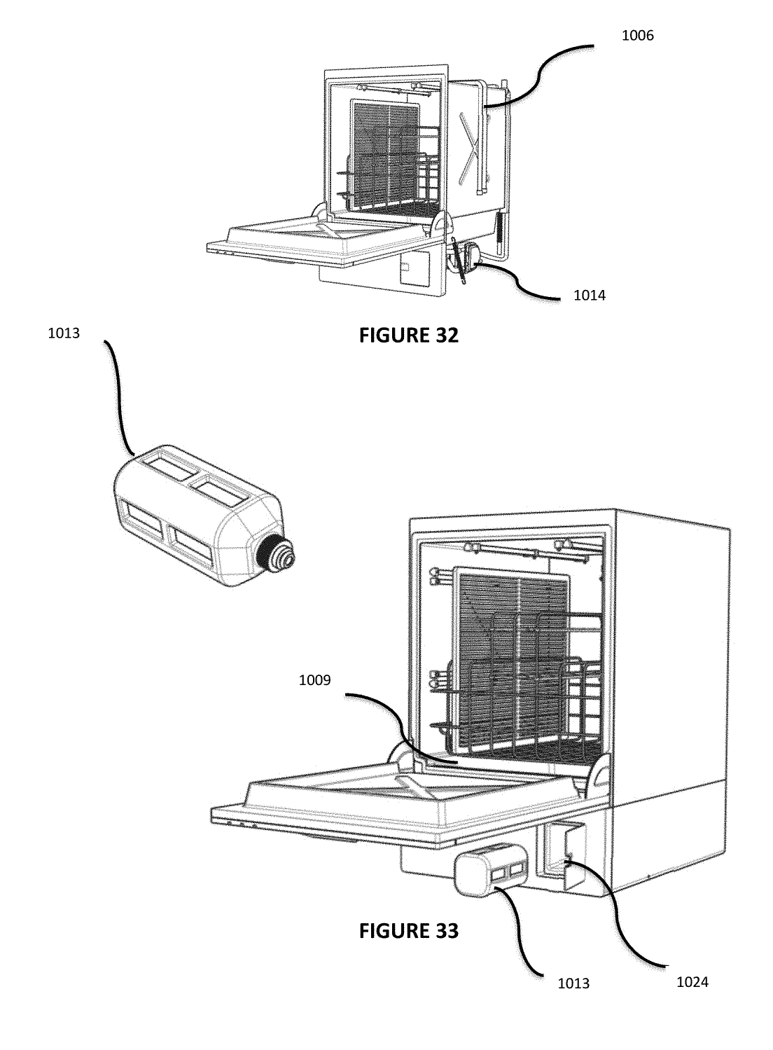

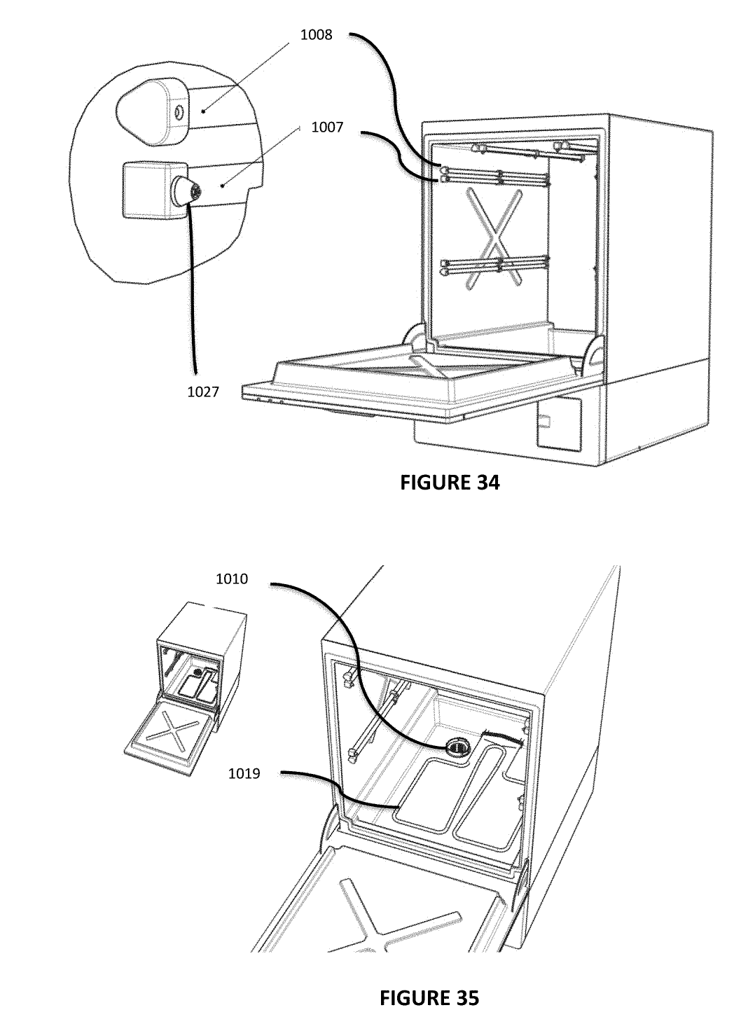

Referring to FIGS. 24 to 36 there is shown a heavy duty washing apparatus 1000 for cleaning cooking substrates including hotplates and grills 1001. The apparatus comprises a ready movable self-contained housing 1002 having an upper washing compartment 1003 and a dual foam and water sub-assembly 1004 (see FIG. 30-32) interconnected to and located beneath the washing compartment. The washing compartment is accessible by a closure 1026 at a front-end portion thereof.

FIGS. 24 and 25 show front and rear views of the washing apparatus respectively including a skirting façade 1023 extending about the lower portion of the housing. The skirting façade includes a door 1024 in a lower corner. The door 1024 allows access to an inlet when opened (see FIG. 33) for receiving a cartridge 1013 containing a select cleaning fluid composition.

The sub-assembly 1004 further includes a pump or compressor 1014 connected to and downstream from the cleaning composition cartridge 1013. The pump 1014 which is preferably a peristaltic pump can be interconnected to a water source and introduce a predetermined combined amount of water and cleaning agent from the cartridge and cause constant low pressure flow through conduits without exposing pipes and seals to cleaning composition.

There is also shown an operating console 1025 for operating cycles for priming, foaming of cleaning composition, contact time between foamed cleaning composition and soiled article for cleaning, and soaking and rinsing.

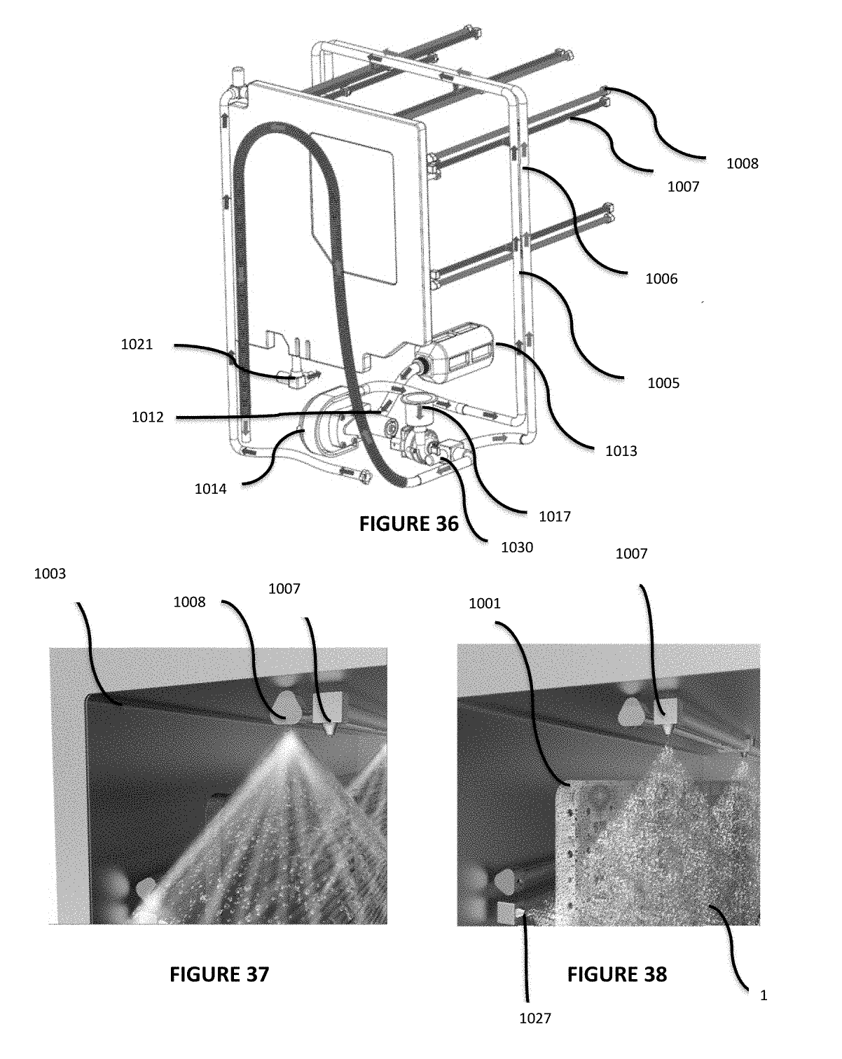

The apparatus further includes a first inlet manifold 1005 (see FIG. 36) for ingress of a foamed cleaning composition and a second inlet manifold 1006 for transfer of water for soaking and rinsing cycles. The first and second inlet manifolds are interconnected to injectors 1007 and shower heads 1008 spaced in parallel pairs about internal surfaces of the washing compartment for injecting cleaning composition in a foam form and spraying rinsing water respectively.

The washing compartment 1003 includes a base 1009 adapted to receive one or more grill plates or hot plates for cleaning on a slidable grill receiving member 1068, a drainage outlet 1010 and a front closure 1011.

The water and foam sub-assembly 1004 is located beneath the washing compartment supported by the housing. The pump 1014 includes an inlet 1012 for receiving a flow of chemical cleaning agent composition from cartridge 1013, the composition comprising a diluted mixture of composition 1 and 2 in an aqueous solution with a volume ratio of composition 1 and 2 and water is about 1:1:2, wherein Composition 1 is a concentrate cleaning composition comprising:
an amount of about 10-30% w/w NaOH,
an amount of less than about 10% w/w of a surfactant, and
an amount of less than about 10% w/w sodium; and
   wherein Composition 2 is a concentrate cleaning composition comprising:
hypochlorous acid in an amount of less than about 10% w/w, and
sodium hydroxide in an amount of less than about 10% w/w;

The sub-assembly 1004 further includes a compressor 1014 downstream from the cartridge 1013 adapted to receive a measured supply of the chemical cleaning agent composition from the cartridge and combine with a high-pressure air source. In operation, a measured supply of the chemical cleaning agent composition is drawn from the cartridge and combined with a high-pressure air source in the compressor. The compressor produces a foam having a viscosity and adhesiveness characteristic effective to allow retention of the foam on the soiled plates or grills for a period of time. In one embodiment the select cleaning composition is formed into a foam which is effective to maintain contact with residue on a grill or hot plate arranged in a vertical orientation (see FIG. 38) within the washing compartment for at least 15 to 30 minutes. The selection of cleaning composition allows formation of a foam which can maintain contact sufficient to react with food residues such as oils, grease, proteins and fats and cause degradation such that a following rinsing cycle is effective to clean and remove substantially all residue.

The compressor 1014 is connected to the foam inlet manifold 1005, which as shown is formed about the washing compartment in a substantially rectangular array. Inside the washing compartment (see FIGS. 37 and 38) there is shown a series of foam injectors 1007 mounted to internal wall surfaces, and the walls of the washing compartment being modified to allow fluid connection between the foam inlet manifold 1005 and foam injectors 1007. As shown, the foam injectors include injecting heads 1027 which can inject a spray of foam horizontally and vertically over a predetermined footprint.

The sub-assembly further includes a water reservoir 1017 and a valve 1030 which delivers water at a predetermined temperature and rate in a first condition to the second inlet manifold 1006 at a predetermined time according to a rinsing cycle. In a second valve condition, the water reservoir allows egress of water from the chamber.

As shown in FIG. 37, water is introduced into the washing compartment in a stream or spray via shower heads 1008 mounted to internal surfaces of the washing compartment. As shown, the water inlet manifold 1006 is formed about the washing compartment in a substantially rectangular array in parallel with the foam inlet manifold 1005. The walls of the washing compartment are modified to allow fluid connection between the inlet manifold 1006 and shower heads 1008.

In one embodiment the washing compartment can be primed by heating. As shown in FIG. 35, the washing compartment includes a heating element 1019 which can preheat the compartment for preliminary treatment of a soiled substrate, the temperature improving rate of decomposition of food residue before treatment with foamed cleaning composition and rinsing. In another embodiment the soiled articles can be soaked in water and heated and left to soak for a predetermined period. The sub-assembly may also include a switching means 1030 which controls washing foaming rinsing cycles and times between the sub-assembly and the washing compartment and removal of waste from the compartment.

The washing compartment includes a drain 1010 in a floor portion thereof connectable externally to a waste outlet 1021. The arrangement of shower heads 1008 on internal wall surfaces of the washing compartment and timing of rinsing cycle can be predetermined such that a front of rinsing water can be provided to assist directing flow of foamed cleaning composition towards the drain.

As a consequence of the present invention the applicant has shown a vastly improved washing system for heavily soiled articles, and significant reduction in labour intensity and efficiency.

Benefits of the system include:

a. The step of washing can be achieved substantially without the need for cycling water flushing;

b. The use of a chemical agent that unlike detergents does not require constant water flushing;

c. The use of a chemical agent which is allowed time to be effective;

d. The use of foaming to provide an effective chemical agent at the surface to allow better aerobic, chemical cleaning due to longer retention times of a foam even on vertical surfaces due to low weight, low viscosity, increased effective surface area and allowance of air passage to cooking substrate surface being cleaned;

e. The use of more intensive chemicals for more intensive cleaning while maintaining safe controlled operation;

f. improves working efficiency and reduces labour intensity—the overall effect is a dramatic increase in economic productivity in the industry;

g. the material can be substantially maintained in an effective condition readily for manipulating by the mobile washer unit during a washing step.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the description provided herein, numerous specific details are set forth. However, it is understood that embodiments of the invention may be practiced without these specific details. In other instances, well-known methods, structures and techniques have not been shown in detail in order not to obscure an understanding of this description.

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

The claims defining the invention are as follows:

1. A heavy duty washing apparatus for cleaning cooking substrates including hotplates and grills comprising:
a. a self-contained housing allowing readily movability;
b. a plurality of functionally interconnected stations for receiving supply of water, a chemical cleaning agent composition and a pressurised fluid;
c. a pressurising station and a temperature conditioning station;
d. a foam generator in the housing using controlling feeds from the plurality of interconnected stations and functionally engaging with the pressurising station and the temperature conditioning station for providing an effective chemical cleaning agent composition for conditioning one or more of the supply of water, the chemical cleaning agent composition and the pressurised fluid and
e. a washing compartment adapted to receive one or more of the cooking substrates in a stackable substantially planar spaced array;
wherein the effective chemical cleaning agent composition allows for cleaning over an effective cleaning time in a chemical, aerobic and physical manner cooking residues on the cooking substrates by retaining of said foam layer for a predetermined period in contact with the cooking surfaces, and rinsing the foam layer with preselected conditioned high temperature and/or pressurised water to remove chemical and food residues.

2. A heavy duty washing apparatus according to claim 1, wherein the washing compartment includes one or more chambers which each further includes:
a. a base adapted to receive one or more grill plates or hot plates for cleaning, the base being divided into a grill plate or hot plate receiving portion and a drainage portion adjacent the grill plate receiving portion, wherein the grill plate receiving portion and drainage portion define a flow pathway therebetween to an outlet in the drainage; and
b. an adjustable closure operable between a closed position and an open position between the grill plate receiving portion and the drainage portion:
c. a cleaning sub-assembly mounted to the chamber, the sub-assembly having:
i.a foam generating system interconnected to a concentrate cleaning composition, a water supply, and compressed air source for producing a cleaning foam composition of predetermined concentration and adhesiveness of between about 15 minutes to 30 minutes;
ii.a foam manifold interconnected to the foam generating system suspended a predetermined distance from the grill plate receiving portion of the base, and
iii.a rinsing manifold interconnected to the water supply;
d. wherein in an operating condition, the grill plate receiving portion of the base receives a predetermined volume of the foamed composition to allow predetermined contact adhesion with the grill plate for a predetermined time, and exposing the foam composition to a rinsing cycle by the rinsing manifold, when the closure is moved to an open position to displace the foam composition to the drainage sump and outlet via the flow pathway.

3. A heavy duty washing apparatus according to claim 1, wherein the effective chemical cleaning agent composition comprises:
a first composition of a concentrate cleaning composition comprising:
an amount of about 10-30% w/w NaOH,
an amount of less than about 10% w/w of a surfactant, and
an amount of less than about 10% w/w sodium;
a second composition of a concentrate cleaning composition comprising:
hypochlorous acid in an amount of less than about 10% w/w, and
sodium hydroxide in an amount of less than about 10% w/w; and
wherein the chemical cleaning agent is diluted with water such that composition 1:composition 2:water are provided in a ratio of about 1:1:2.

4. A heavy duty washing apparatus according to claim 1, wherein the plurality of interconnected stations and the washing apparatus is connectable to the water supply feeding to the foam generator and the washing compartment connected downstream of the foam generator is controlling the supply of the chemical cleaning agent composition, water and pressurising fluid from the interconnected stations to provide the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact of between about 15 minutes to 30 minutes.

5. A heavy duty washing apparatus according to claim 1, wherein the outlet of the washing compartment has a sealable closure switchable between two or more of the following:
a. projection mode for sealing washing compartment and allowing projection of effective chemical cleaning agent composition into the sealed washing compartment without chance of dispersal to the atmosphere;
b. washing mode for allowing time effective cleaning in the sealed washing compartment while allowing pressure and temperature condition;
c. deactivation mode in which the washing compartment is sealed for receipt of deactivating water or chemical deactivates foam of the effective chemical cleaning agent composition without dispersal to the atmosphere;
d. first dispersal mode in which the washing compartment is sealed for receipt of flushing water or chemical for flushing of the effective chemical cleaning agent composition towards a drainage sump without dispersal to the atmosphere;
e. second dispersal mode in which drainage sump is open for drainage of the flushed and/or deactivated effective chemical cleaning agent composition.

6. A heavy duty washing apparatus according to claim 1, wherein the plurality of interconnected stations within the housing including:
a. a water station having input connection for supplying water and the water station preferably including associated temperature and pressure modules for conditioning of the temperature and/or pressure of the water;
b. a chemical station having input connection for a chemical cleaning agent composition preferably from a pressurised canister;
c. a pressure station for supplying pressurised fluid preferably as air pressure;

7. A heavy duty washing apparatus according to claim 1, wherein a supply controller connected to the fluid interconnection to the washing compartment directly or indirectly from the interconnected stations in order to provide:
a. a chemical cleaning agent composition in an effective form;
b. water separately or in combination with the chemical cleaning agent composition in order to aid the provision of the chemical cleaning agent composition in an effective form;
c. pressurising fluid separately or in combination with water and/or with the chemical cleaning agent composition in order to aid the provision of the chemical cleaning agent composition in an effective form;
d. dispersing, via the series of inlets to the washing compartment, the effective form of the chemical cleaning agent composition along the substantially spaced planar array of the cooking substrates;

8. A heavy duty washing apparatus according to claim 1, further including a foaming controller controlling the supply of the chemical cleaning agent composition, water and pressurising fluid from the interconnected stations to provide
a. the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact of between about 15 minutes to 30 minutes;
b. an effective chemical cleaning agent composition for cleaning in a chemical, aerobic and physical manner cooking residues on the cooking substrates;

9. A heavy duty washing apparatus according to claim 1, further including a projection controller controlling the projection of the effective chemical cleaning agent composition into the washing compartment wherein the projection control provides:
a. a dispersal of the effective chemical cleaning agent composition in the form of the foam at low pressure and wide foaming dispersal jets or nozzles which allows the foam to be retained on the cooking substrates to allow producing a cleaning foam composition of predetermined concentration and adhesiveness of between about 15 minutes to 30 minutes;
b. and a high temperature in the washing compartment preferably greater than 75 degrees Celsius to aid chemical and/or water cleaning to the cooking substrates in the washing compartment and/or
c. a high pressure projection of effective chemical cleaning agent composition and/or water to aid physical cleaning;
and the projection control provides controlling the dispersal of the effective chemical cleaning agent composition by application of one or more of:
d. supply and control of water to provide flushing;
e. supply and control of chemical dispersal agent to provide deactivation or flow characteristics of the effective chemical cleaning agent composition;
f. supply and control of pressurised fluid into the washing compartment wherein the control aids flushing;

10. A heavy duty washing apparatus according to claim 9, wherein the apparatus further includes an integrated processor means for controlling conditions at the conditioning stations.

11. A heavy duty washing apparatus according to claim 1, wherein the washing compartment includes one or more chambers which each further includes:
a. a base adapted to receive one or more grill plates or hot plates for cleaning, the base being divided into a grill plate or hot plate receiving portion and a drainage portion adjacent the grill plate receiving portion, wherein the grill plate receiving portion and drainage portion define a flow pathway therebetween to an outlet in the drainage; and
b. an adjustable closure operable between a closed position and an open position between the grill plate receiving portion and the drainage portion:
c. a cleaning sub-assembly mounted to the chamber, the sub-assembly having:
i.a foam generating system interconnected to a concentrate cleaning composition, a water supply, and compressed air source for producing a cleaning foam composition of predetermined concentration and adhesiveness of between about 15 minutes to 30 minutes;
ii.a foam manifold interconnected to the foam generating system suspended a predetermined distance from the grill plate receiving portion of the base, and
iii.a rinsing manifold interconnected to the water supply;
d. wherein in an operating condition, the grill plate receiving portion of the base receives a predetermined volume of the foamed composition to allow predetermined contact adhesion with the grill plate for a predetermined time, and exposing the foam composition to a rinsing cycle by the rinsing manifold, when the closure is moved to an open position to displace the foam composition to the drainage sump and outlet via the flow pathway.

12. A heavy duty washing apparatus according to claim 5, wherein the washing compartment comprises a plurality of inlets spaced about the compartment to spray conditioned water over the soiled substrates.

13. A heavy duty washing apparatus according to claim 12, wherein the inlets in the washing compartment include a terminal spray head adjustably located in the washing compartment for dispersing conditioned water and foam over surfaces of stacked cooking plates, grills and accessories.

14. A heavy duty washing apparatus according to claim 11, wherein the washing apparatus further include a means for introducing a fluid or chemical under pressure to the washing compartment.

15. A heavy duty washing apparatus according to claim 14, wherein the apparatus includes a canister containing a chemical cleaning agent, whereby the canister is loaded into a dedicated inlet assembly on the mobile housing, wherein the inlet assembly is interconnectable to a pump supported by the sub-assembly downstream thereto for drawing an amount of the chemical cleaning agent and transferring the chemical agent to the foam manifold under low pressure, wherein the transported chemical agent enters the washing compartment in a first cycle through the inlets, wherein the fluid forms a foam layer on contact with a surface to be cleaned and wherein the foam layer remains on the contact surfaces for a preselect period of time.

16. A method of heavy duty washing of cooking substrates including hotplates and grills, the method including the steps of:
a. providing a self-contained housing having at least one washing compartment therein and which housing can be readily movable, and the washing compartment adapted to receive one or more of the cooking substrates in a stackable substantially spaced planar array, wherein the washing compartment includes a series of inlets and an internal non-corrosive liner and at least one outlet;
b. providing a plurality of interconnected stations within the housing including:
i. a water station having input connection for supplying water and the water station preferably including associated temperature and pressure modules for conditioning of the temperature and/or pressure of the water;
ii. a chemical station having input connection for a chemical cleaning agent composition preferably from a pressurised canister;
iii. a pressure station for supplying pressurised fluid preferably as air pressure;
c. providing fluid interconnection to the washing compartment directly or indirectly from the interconnected stations in order to provide:
i. a chemical cleaning agent composition in an effective form;
ii. water separately or in combination with the chemical cleaning agent composition in order to aid the provision of the chemical cleaning agent composition in an effective form;
iii. pressurising fluid separately or in combination with water and/or with the chemical cleaning agent composition in order to aid the provision of the chemical cleaning agent composition in an effective form;
iv. dispersing, via the series of inlets to the washing compartment, the effective form of the chemical cleaning agent composition along the substantially spaced planar array of the cooking substrates;
d. controlling the supply of the chemical cleaning agent composition, water and pressurising fluid from the interconnected stations to provide
i. the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact of between about 15 minutes to 30 minutes;
ii. an effective chemical cleaning agent composition for cleaning in a chemical, aerobic and physical manner cooking residues on the cooking substrates;
e. controlling the projection of the effective chemical cleaning agent composition into the washing compartment wherein the control provides:
i. a dispersal of the effective chemical cleaning agent composition in the form of the foam at low pressure and wide foaming dispersal jets or nozzles which allows the foam to be retained on the cooking substrates to allow producing a cleaning foam composition of predetermined concentration and adhesiveness of between about 15 minutes to 30 minutes;
ii. and a high temperature in the washing compartment preferably greater than 75 degrees Celsius to aid chemical and/or water cleaning to the cooking substrates in the washing compartment and/or
iii. a high pressure projection of effective chemical cleaning agent composition and/or water to aid physical cleaning;
f. controlling the dispersal of the effective chemical cleaning agent composition by application of one or more of:
i. supply and control of water to provide flushing;
ii. supply and control of chemical dispersal agent to provide deactivation or flow characteristics of the effective chemical cleaning agent composition
iii. supply and control of pressurised fluid into the washing compartment wherein the control aids flushing;
wherein the method allows retaining of said foam layer for a predetermined period in contact with the cooking surfaces, and
rinsing the foam layer with preselected conditioned high temperature and/or pressurised water to remove chemical and food residues.

17. A heavy duty washing apparatus for cleaning cooking substrates including hotplates and grills comprising:
a. a self-contained housing allowing readily movability;
b. a plurality of functionally interconnected stations for receiving supply of water, a chemical cleaning agent composition and a pressurised fluid;
c. a pressurising station and a temperature conditioning station;
d. a foam generator in the housing using controlling feeds from the plurality of interconnected stations and functionally engaging with the pressurising station and the temperature conditioning station for providing an effective chemical cleaning agent composition for conditioning one or more of the supply of water, the chemical cleaning agent composition and the pressurised fluid and
e. a washing compartment adapted to receive one or more of the cooking substrates in a stackable substantially planar spaced array;
wherein the plurality of interconnected stations and the washing apparatus is connectable to the water supply feeding to the foam generator and the washing compartment connected downstream of the foam generator is controlling the supply of the chemical cleaning agent composition, water and pressurising fluid from the interconnected stations to provide the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact for a predetermined period of time for solubilising residues of oil, grease and foods; and
wherein the effective chemical cleaning agent composition allows for cleaning over an effective cleaning time in a chemical, aerobic and physical manner cooking residues on the cooking substrates by retaining of said foam layer for a predetermined period in contact with the cooking surfaces, and rinsing the foam layer with preselected conditioned high temperature and/or pressurised water to remove chemical and food residues.

18. A heavy duty washing apparatus according to claim 17, wherein the effective chemical cleaning agent composition is selected from:
Composition 1: a concentrate cleaning composition comprising:
an amount of about 10-30% w/w NaOH,
an amount of less than about 10% w/w of a surfactant, and
an amount of less than about 10% w/w sodium.
Composition 2: a concentrate cleaning composition comprising:
hypochlorous acid in an amount of less than about 10% w/w, and
sodium hydroxide in an amount of less than about 10% w/w;
Composition 3: a concentrate cleaning composition comprising:
Potassium Hydroxide in an amount of less than about 6% w/w, and
sodium hypochlorite in an amount of less than about 6% w/w
Composition 4: a diluted mixture of composition 1 and 2 in an aqueous solution with a volume ratio of composition 1 and 2 and water is about 1:1:2.

19. A heavy duty washing apparatus according to claim 17, wherein the washing compartment includes one or more chambers which each further includes:
a. a base adapted to receive one or more grill plates or hot plates for cleaning, the base being divided into a grill plate or hot plate receiving portion and a drainage portion adjacent the grill plate receiving portion, wherein the grill plate receiving portion and drainage portion define a flow pathway therebetween to an outlet in the drainage; and
b. an adjustable closure operable between a closed position and an open position between the grill plate receiving portion and the drainage portion:
c. a cleaning sub-assembly mounted to the chamber, the sub-assembly having:
i. a foam generating system interconnected to a concentrate cleaning composition, a water supply, and compressed air source for producing a cleaning foam composition of predetermined concentration and adhesiveness of between about 15 minutes to 30 minutes;
ii. a foam manifold interconnected to the foam generating system suspended a predetermined distance from the grill plate receiving portion of the base, and
iii. a rinsing manifold interconnected to the water supply;
d. wherein in an operating condition, the grill plate receiving portion of the base receives a predetermined volume of the foamed composition to allow predetermined contact adhesion with the grill plate for a predetermined time, and exposing the foam composition to a rinsing cycle by the rinsing manifold, when the closure is moved to an open position to displace the foam composition to the drainage sump and outlet via the flow pathway.

20. A heavy duty washing apparatus according to claim 19, wherein the self-contained housing further includes:
an inlet port for receiving a cartridge containing chemical cleaning agent composition selected from any of the compositions in claim 18;
wherein the cleaning sub-assembly is located beneath the washing compartment and supported by the housing, the sub-assembly further comprising a compressor downstream from the inlet port adapted to receive a measured supply of the chemical cleaning agent composition from the cartridge and combine with a high pressure air source, wherein the compressor combines with air to produce a foam having viscosity and adhesive characteristics effective to allow retention of the foam on soiled plates or grills for a predetermined period of time;
a water reservoir having an inlet connectable to a water supply wherein the water reservoir is delivered to the rinsing manifold at a predetermined time according to a rinsing cycle;
a switching means for controlling washing cycles between the sub-assembly and the washing compartment and removal of waste from the compartment;
foam injectors and shower heads for directional ingress of cleaning foam composition and rinsing water according to a predetermined washing cycle, the foam injectors and shower heads located in spaced apart parallel pairs on internal walls of the washing compartment, wherein the foam and rinsing manifolds extend externally of the washing compartment in fluid communication with the foam injectors and shower heads;
wherein in a cleaning condition the compressor delivers foam to the washing compartment via the foam manifold and foam injectors into the washing compartment, and separate ingress of water via shower heads for rinsing the foam.

21. A method of heavy duty washing of cooking substrates including hotplates and grills, the method including the steps of:
a. providing a self-contained housing having at least one washing compartment therein and which housing can be readily movable, and the washing compartment adapted to receive one or more of the cooking substrates in a stackable substantially spaced planar array, wherein the washing compartment includes a series of inlets and an internal non-corrosive liner and at least one outlet;
b. providing a plurality of interconnected stations within the housing including:
i. a water station having input connection for supplying water and the water station preferably including associated temperature and pressure modules for conditioning of the temperature and/or pressure of the water;
ii. a chemical station having input connection for a chemical cleaning agent composition preferably from a pressurised canister;
iii. a pressure station for supplying pressurised fluid preferably as air pressure;
c. providing fluid interconnection to the washing compartment directly or indirectly from the interconnected stations in order to provide:
i. a chemical cleaning agent composition in an effective form;
ii. water separately or in combination with the chemical cleaning agent composition in order to aid the provision of the chemical cleaning agent composition in an effective form;
iii. pressurising fluid separately or in combination with water and/or with the chemical cleaning agent composition in order to aid the provision of the chemical cleaning agent composition in an effective form;
iv. dispersing, via the series of inlets to the washing compartment, the effective form of the chemical cleaning agent composition along the substantially spaced planar array of the cooking substrates;
d. controlling the supply of the chemical cleaning agent composition, water and pressurising fluid from the interconnected stations to provide
i. the effective chemical cleaning agent composition in the form of a foam by a foam generating system interconnected to a concentrate cleaning composition, a water supply, and compressed air source for producing the effective chemical cleaning agent composition in a cleaning foam composition of predetermined concentration and adhesiveness wherein application to a planar vertical surface of a hotplate or grill is substantially retaining contact of between about 15 minutes to 30 minutes;
ii. an effective chemical cleaning agent composition for cleaning in a chemical, aerobic and physical manner cooking residues on the cooking substrates;
e. controlling the projection of the effective chemical cleaning agent composition into the washing compartment wherein the control provides:
i. a dispersal of the effective chemical cleaning agent composition in the form of the foam at low pressure and wide foaming dispersal jets or nozzles which allows the foam to be retained on the cooking substrates to allow producing a cleaning foam composition of predetermined concentration and adhesiveness of between about 15 minutes to 30 minutes;
ii. and a high temperature in the washing compartment preferably greater than 75 degrees Celsius to aid chemical and/or water cleaning to the cooking substrates in the washing compartment and/or
iii. a high pressure projection of effective chemical cleaning agent composition and/or water to aid physical cleaning;
f. controlling the dispersal of the effective chemical cleaning agent composition by application of one or more of:
i. supply and control of water to provide flushing;
ii. supply and control of chemical dispersal agent to provide deactivation or flow characteristics of the effective chemical cleaning agent composition
iii. supply and control of pressurised fluid into the washing compartment wherein the control aids flushing;
wherein the method allows retaining of said foam layer for a predetermined period in contact with the cooking surfaces, and
rinsing the foam layer with preselected conditioned high temperature and/or pressurised water to remove chemical and food residues.
